(19) United States
(12) Patent Application Publication
(10) Pub. No.: US 2012/0265385 A1
(43) Pub. Date: Oct. 18, 2012

(54) NONAQUEOUS ELECTROLYTE BATTERY AND NONAQUEOUS ELECTROLYTE, AND BATTERY PACK, ELECTRONIC APPLIANCE, ELECTRIC VEHICLE, ELECTRICITY STORAGE APPARATUS, AND ELECTRIC POWER SYSTEM

(75) Inventors: Yusuke Funada, Fukushima (JP); Ichiro Yamada, Fukushima (JP); Tadahiko Kubota, Kanagawa (JP)

(73) Assignee: SONY CORPORATION, Tokyo (JP)

(21) Appl. No.: 13/437,650

(22) Filed: Apr. 2, 2012

(30) Foreign Application Priority Data
Apr. 13, 2011 (JP) 2011-089522

(51) Int. Cl. G06F 7/00; H01M 2/02; H02J 7/00; H01M 10/056

(52) U.S. Cl. 701/22; 429/188; 429/199; 429/163; 320/128

(57) ABSTRACT

A nonaqueous electrolyte battery includes: a positive electrode, a negative electrode, and a nonaqueous electrolyte containing a nonaqueous electrolytic solution, wherein the nonaqueous electrolytic solution contains a compound represented by the following general formula (I)

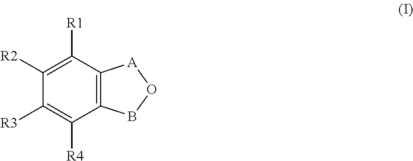

wherein, in the general formula (I), each of R1 to R4 independently represents a group having a hydrocarbon group having at least one aromatic ring and at least one unsaturated bond or a hydrogen atom, provided that at least one of R1 to R4 is a group having a hydrocarbon group having at least one aromatic ring and at least one unsaturated bond; and each of A and B independently represents a carbonyl group, a sulfonyl group, or a methylene group, provided that at least one of A and B is a carbonyl group or a sulfonyl group.

### CROSS REFERENCES TO RELATED APPLICATIONS

The present application claims priority to Japanese Priority Patent Application JP 2011-089522 filed in the Japan Patent Office on Apr. 13, 2011, the entire content of which is hereby incorporated by reference.

### BACKGROUND

The present disclosure relates to a nonaqueous electrolyte battery and a nonaqueous electrolyte and also to a battery pack, an electronic appliance, an electric vehicle, an electricity storage apparatus, and an electric power system. In more detail, the present disclosure relates to a nonaqueous electrolyte battery using a nonaqueous electrolyte containing a nonaqueous solvent and an electrolyte salt and also to a battery pack, an electronic appliance, an electric vehicle, an electricity storage apparatus, and an electric power system each using a nonaqueous electrolyte battery.

In recent years, portable electronic appliances such as a camera-integrated VTR (video tape recorder), a mobile phone, and a laptop PC (personal computer) have widely spread, and it is strongly demanded to realize downsizing, weight reduction, and long life thereof. Following this, the development of batteries as a portable power source for electronic appliances, in particular, secondary batteries which are lightweight and from which a high energy density is obtainable is advanced.

Above all, so-called lithium ion secondary batteries utilizing intercalation and deintercalation of lithium (Li) for a charge and discharge reaction are widely put into practical use because a high energy density is obtainable as compared with lead batteries and nickel-cadmium batteries which are a nonaqueous electrolytic solution secondary battery in the related art. Such a lithium ion secondary battery is provided with an electrolyte that is an ionically conductive medium, together with a positive electrode and a negative electrode.

The nonaqueous electrolytic solution that is a liquid electrolyte, which is used for nonaqueous electrolytic solution batteries, is in general constituted mainly of an electrolyte salt and a nonaqueous solvent. As a main component of the nonaqueous solvent, a cyclic carbonate such as ethylene carbonate and propylene carbonate; a chain carbonate such as dimethyl carbonate, diethyl carbonate, and ethyl methyl carbonate; a cyclic carboxylate such as γ-butyrolactone and γ-valerolactone; and so on are used.

Also, in order to improve battery characteristics, such as a load characteristic, a cycle characteristic, and a storage characteristic, of such a nonaqueous electrolytic solution battery or to enhance the safety of the battery at the time of overcharge, there have been made many studies regarding the addition of various additives to the nonaqueous electrolytic solution.

For example, in Japanese Patent No. 2697365, JP-A-7-122297, and JP-A-2001-57236, it is proposed that the storage characteristic of a battery is improved by the addition of an acid anhydride such as benzoic anhydride and phthalic anhydride to an electrolytic solution. Also, in JP-A-5-198317 and JP-A-2002-008718, it is proposed that the high-temperature storage characteristic is improved, or the cycle characteristic is improved by the addition of phthalide or 2-sulfobenzoic acid, each of which is analogous to phthalic anhydride, to an electrolytic solution.

### SUMMARY

The requirement for realization of high performances on batteries in recent years is increasing more and more, and it is demanded to achieve battery characteristics such as a high capacity, a high-temperature storage characteristic, and a cycle characteristic on a high level.

Thus, it is desirable to provide a nonaqueous electrolyte battery and a nonaqueous electrolyte, each of which is capable of enhancing a high-temperature storage characteristic, and also a battery pack, an electronic appliance, an electric vehicle, an electricity storage apparatus, and an electric power system each using a nonaqueous electrolyte battery.

One embodiment of the present disclosure is directed to a nonaqueous electrolyte battery including a positive electrode, a negative electrode, and a nonaqueous electrolyte containing a nonaqueous electrolytic solution, wherein the nonaqueous electrolytic solution contains a compound represented by the following general formula (I).

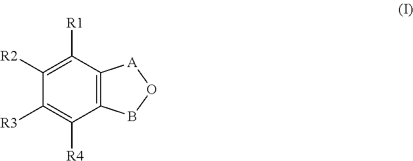

In the general formula (I), each of R1 to R4 independently represents a group having a hydrocarbon group having at least one aromatic ring and at least one unsaturated bond or a hydrogen atom, provided that at least one of R1 to R4 is a group having a hydrocarbon group having at least one aromatic ring and at least one unsaturated bond; and each of A and B independently represents a carbonyl group, a sulfonyl group, or a methylene group, provided that at least one of A and B is a carbonyl group or a sulfonyl group.

Another embodiment of the present disclosure is directed to a nonaqueous electrolyte containing a nonaqueous electrolytic solution containing a compound represented by the following general formula (I).

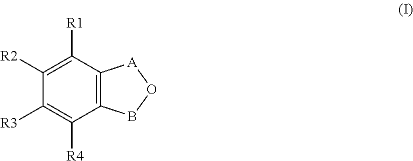

In the general formula (I), each of R1 to R4 independently represents a group having a hydrocarbon group having at least one aromatic ring and at least one unsaturated bond or a hydrogen atom, provided that at least one of R1 to R4 is a group having a hydrocarbon group having at least one aromatic ring and at least one unsaturated bond; and each of A and B independently represents a carbonyl group, a sulfonyl group, or a methylene group, provided that at least one of A and B is a carbonyl group or a sulfonyl group.

Still another embodiment of the present disclosure is directed to a battery pack, an electronic appliance, an electric vehicle, an electricity storage apparatus, and an electric power system including the nonaqueous electrolyte battery of the embodiment of the present disclosure.

In the embodiments of the present disclosure, the nonaqueous electrolytic solution is allowed to contain the compound represented by the general formula (I). According to this, since a side reaction of the electrode active material and the nonaqueous electrolytic solution is suppressed at the time of high-temperature storage, deterioration of the capacity at the time of high-temperature storage can be suppressed.

According to the embodiments of the present disclosure, the high-temperature storage characteristic can be enhanced.

Additional features and advantages are described herein, and will be apparent from the following Detailed Description and the figures.

### BRIEF DESCRIPTION OF THE FIGURES

FIG. 1 is a sectional view showing an example of a configuration of a nonaqueous electrolyte battery according to an embodiment of the present disclosure.

FIG. 2 is a sectional view showing enlargedly a part of a wound electrode body in FIG. 1.

FIG. 3 is an exploded perspective view showing an example of a configuration of a nonaqueous electrolyte battery according to an embodiment of the present disclosure.

FIG. 4 is a sectional view along an I-I line of a wound electrode body in FIG. 3.

FIG. 5 is a block diagram showing an example of a configuration of a battery pack according to an embodiment of the present disclosure.

FIG. 6 is a diagrammatic view showing an example applied to an electricity storage system for house using a nonaqueous electrolyte battery of the embodiment of the present disclosure.

FIG. 7 is a diagrammatic view showing diagrammatically an example of a configuration of a hybrid vehicle adopting a series hybrid system to which the present disclosure is applied.

### DETAILED DESCRIPTION

Embodiments of the present disclosure are hereunder described by reference to the accompanying drawings. Incidentally, the description is made in the following order.

1. First embodiment (a first example of a nonaqueous electrolyte battery)

2. Second embodiment (a second example of a nonaqueous electrolyte battery)

3. Third embodiment (a third example of a nonaqueous electrolyte battery)

4. Fourth embodiment (an example of a battery pack using a nonaqueous electrolyte battery)

5. Fifth embodiment (an example of an electricity storage system or the like using a nonaqueous electrolyte battery)

6. Other embodiments (modification examples)

### 1. First Embodiment

### Configuration of Battery

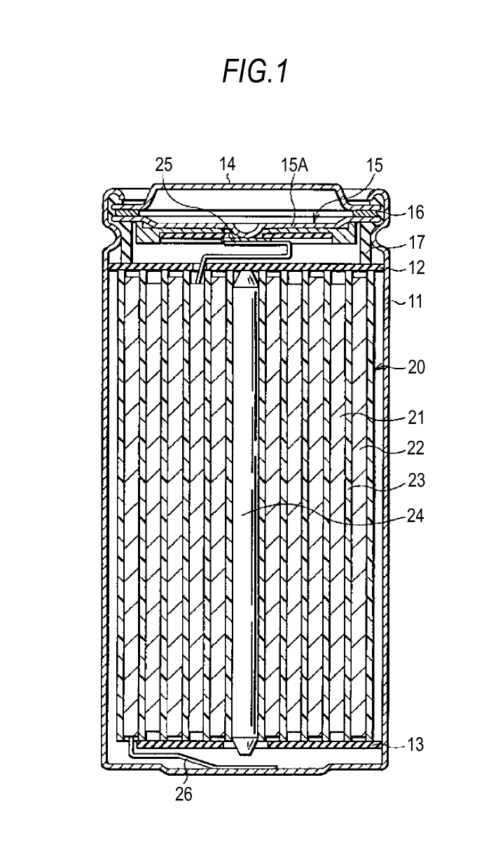

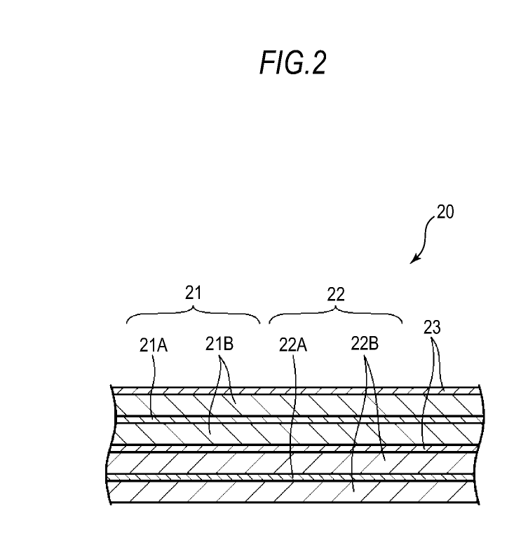

A nonaqueous electrolyte battery according to a first embodiment of the present disclosure is described by reference to FIGS. 1 and 2. FIG. 1 shows a sectional configuration of a nonaqueous electrolyte battery according to the first embodiment of the present disclosure. FIG. 2 shows enlargedly a part of a wound electrode body 20 shown in FIG. 1. This nonaqueous electrolyte battery is, for example, a secondary battery capable of performing charge and discharge, and it is, for example, a lithium ion secondary battery expressed in which the capacity of a negative electrode 22 is expressed on the basis of intercalation and deintercalation of lithium that is an electrode reactant.

This nonaqueous electrolyte battery is one in which the wound electrode body 20 having a positive electrode 21 and a negative electrode 22 laminated and wound therein via a separator 23 and a pair of insulating plates 12 and 13 are mainly housed in the inside of a substantially hollow columnar battery can 11. A battery structure using this columnar battery can 11 is called a cylindrical type.

### (Positive Electrode)

The positive electrode 21 is, for example, one in which a positive electrode active material layer 21B is provided on the both surfaces of a positive electrode collector 21A having a pair of planes. However, the positive electrode active material layer 21B may be provided on only one surface of the positive electrode collector 21A.

The positive electrode collector 21A is, for example, constituted of a metal material such as aluminum, nickel, and stainless steel.

The positive electrode active material layer 21B contains, as a positive electrode active material, one or two or more kinds of positive electrode materials capable of intercalating and deintercalating lithium and may further contain other materials such as a binder and a conductive agent, if desired.

As the positive electrode material capable of intercalating and deintercalating lithium, lithium-containing compounds such as a lithium oxide, a lithium phosphate, a lithium sulfide, and an intercalation compound containing lithium are suitable. A mixture of two or more kinds thereof may be used. In order to increase the energy density, lithium-containing compounds containing lithium, a transition metal element, and oxygen (O) are preferable. Examples of such a lithium-containing compound include a lithium complex oxide having a structure of a layered rock salt represented by the following formula (1); and a lithium complex phosphate having a structure of an olivine type represented by the following formula (2). As the lithium-containing compound, those containing, as the transition metal element, at least one member selected from the group consisting of cobalt (Co), nickel (Ni), manganese (Mn), and iron (Fe) are more preferable. Examples of such a lithium-containing compound include a lithium complex oxide having a structure of a layered rock salt type represented by the following formula (3), (4) or (5); a lithium complex oxide having a structure of a spinel type represented by the following formula (6); and a lithium complex phosphate having a structure of an olivine type represented by the following formula (7). Specific examples thereof include LiNi_{0.50}Co_{0.20}Mn_{0.30}O₂, LiₐCoO₂ (a≅1), Li_{b}NiO₂ (b≅1), Li_{c1}Ni_{c2}Co_{1-c2}O₂ (c1≅1, 0<c2<1), Li_{d}Mn₂O₄ (d≅1), and LiₑFₑPO₄ (e≅1).

LiₚNi_{(1-q-r)}Mn_{q}M1ᵣO_{(2-y)}X_{z} (1)

In the formula (1), M1 represents at least one member selected from the group consisting of elements of the groups 2 to 15 other than nickel (Ni) and manganese (Mn); X represents at least one member selected from the group consisting of elements of the groups 16 and 17 other than oxygen (O); and p, q, r, y, and z are values falling within the ranges of 0≦p≦1.5, 0≦q≦1.0, 0≦r≦1.0, −0.10≦y≦0.20, and 0≦z≦0.2, respectively.

LiₐM2_{b}PO₄ (2)

In the formula (2), M2 represents at least one member selected from the group consisting of elements of the groups 2 to 15; and a and b are values falling within the ranges of 0≦a≦2.0 and 0.5≦b≦2.0, respectively.

Li_{f}Mn_{(1-g-h)}Ni_{g}M3ₕO₍₂₋ⱼ₎Fₖ (3)

In the formula (3), M3 represents at least one member selected from the group consisting of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W); and f, g, h, j, and k are values falling within the ranges of 0.8≦f≦1.2, 0<g<0.5, 0≦h≦0.5, (g+h)<1, −0.1≦j≦0.2, and 0≦k≦0.1, respectively. Incidentally, the composition of lithium varies depending upon the state of charge and discharge; and the value off represents a value in a completely discharged state.

LiₘNi₍₁₋ₙ₎M4ₐO₍₂₋ₚ₎F_{q} (4)

In the formula (4), M4 represents at least one member selected from the group consisting of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); and m, n, p, and q represent values falling within the ranges of 0.8≦m≦1.2, 0.005≦n≦0.5, −0.1≦p≦0.2, and 0≦q≦0.1, respectively. Incidentally, the composition of lithium varies depending upon the state of charge and discharge, and the value of m represents a value in a completely discharged state.

LiᵣCo₍₁₋ₛ₎M5ₛO₍₂₋ₜ₎Fᵤ (5)

In the formula (5), M5 represents at least one member selected from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); and r, s, t, and u represent values falling within the ranges of 0.8≦r≦1.2, 0≦s<0.5, −0.1≦t≦0.2, and 0≦u≦0.1, respectively. Incidentally, the composition of lithium varies depending upon the state of charge and discharge, and the value of r represents a value in a completely discharged state.

LiᵥMn_{2-w}M6_{w}OₓF_{y} (6)

In the formula (6), M6 represents at least one member selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W); and v, w, x, and y represent values falling within the ranges of 0.9≦v≦1.1, 0≦w≦0.6, 3.7≦x≦4.1, and 0≦y≦0.1, respectively. Incidentally, the composition of lithium varies depending upon the state of charge and discharge, and the value of v represents a value in a completely discharged state.

Li_{z}M7PO₄ (7)

In the formula (7), M7 represents at least one member selected from the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr); and z represents a value falling within the range of 0.9≦z≦1.1. Incidentally, the composition of lithium varies depending upon the state of charge and discharge, and the value of z represents a value in a completely discharged state.

In addition to the foregoing positive electrode materials, lithium-free inorganic compounds such as MnO₂, V₂O₅, V₆O₁₃, NiS, and MoS can be exemplified, too as the positive electrode material capable of intercalating and deintercalating lithium.

The positive electrode material capable of intercalating and deintercalating lithium may also be a material other than those described above. Also, two or more kinds of the above-exemplified positive electrode materials may be mixed in an arbitrary combination.

Examples of the binder include synthetic rubbers such as a styrene butadiene based rubber, a fluorine based rubber, and an ethylene propylene diene based rubber; and polymer materials such as polyvinylidene fluoride. These materials may be used singly or in admixture of plural kinds thereof.

Examples of the conductive agent include carbon materials such as graphite and carbon black. These materials are used singly or in admixture of plural kinds thereof. Incidentally, the conductive agent may be a metal material, a conductive polymer, or the like so far as it is a material having conductivity.

### (Negative Electrode)

The negative electrode 22 is, for example, one in which a negative electrode active material layer 22B is provided on the both surfaces of a negative electrode collector 22A having a pair of planes. However, the negative electrode active material layer 22B may be provided on only one surface of the negative electrode collector 22A.

The negative electrode collector 22A is, for example, constituted of a metal material such as copper, nickel, and stainless steel.

The negative electrode active material layer 22B contains, as a negative electrode active material, one or two or more kinds of a negative electrode material capable of intercalating and deintercalating lithium and may also contain other materials such as a binder and a conductive agent, if desired. In this negative electrode active material layer 22B, for the purpose of preventing deposition of the lithium metal without intention from occurring at the time of charge and discharge, it is preferable that the chargeable capacity of the negative electrode material is larger than the discharge capacity of the positive electrode 21. Incidentally, as the binder and the conductive agent, the same materials as those described for the positive electrode can be used, respectively.

Examples of the negative electrode material capable of intercalating and deintercalating lithium include carbon materials. Examples of such a carbon material include artificial graphites such as hardly graphitized carbon, easily graphitized carbon, and MCMB (mesocarbon microbead), natural graphite, pyrolytic carbons, cokes, graphites, vitreous carbons, organic polymer compound baked materials, carbon blacks, carbon fibers, and active carbons. Of these, examples of the cokes include pitch coke, needle coke, and petroleum coke. The organic polymer compound baked material as referred to herein is a material obtained through carbonization by baking a polymer material such as a phenol resin and a furan resin at an appropriate temperature, and a part thereof is one which is classified into hardly graphitized carbon or easily graphitized carbon.

In addition to the foregoing carbon materials, examples of the negative electrode material capable of intercalating and deintercalating lithium include a material capable of intercalating and deintercalating lithium and containing, as a constituent element, at least one member selected from the group consisting of metal elements and semi-metal elements. This is because a high energy density is obtainable. Such a negative electrode material may be a simple substance, an alloy or a compound of a metal element or a semi-metal element. Also, a material having one or two or more kinds of a phase in at least a part thereof may be used. Incidentally, the “alloy” as referred to in the present disclosure includes, in addition to alloys composed of two or more kinds of a metal element, alloys containing one or more kinds of a metal element and one or more kinds of a semi-metal element. Also, the “alloy” may contain a non-metal element. Examples of its texture include a solid solution, a eutectic (eutectic mixture), an intermetallic compound, and one in which two or more kinds thereof coexist.

Examples of the metal element or semi-metal element include a metal element or a semi-metal element capable of forming an alloy together with lithium. Specific examples thereof include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt). Of these, at least one member selected from silicon and tin is preferable, and silicon is more preferable. This is because silicon and tin have large capability to intercalate and deintercalate lithium, so that a high energy density is obtainable.

Examples of the negative electrode material containing at least one member selected from silicon and tin include a simple substance, an alloy or a compound of silicon; a simple substance, an alloy or a compound of tin; and a material having one kind or two or more kinds of a phase in at least a part thereof.

Examples of alloys of silicon include alloys containing, as a second constituent element other than silicon, at least one member selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr). Examples of alloys of tin include alloys containing, as a second constituent element other than tin (Sn), at least one member selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr).

Examples of compounds of tin or compounds of silicon include compounds containing oxygen (O) or carbon (C), and these compounds may further contain the foregoing second constituent element in addition to tin (Sn) or silicon (Si).

In particular, as the negative electrode material containing at least one member selected from silicon (Si) and tin (Sn), for example, a material containing tin (Sn) as a first constituent element and in addition to this tin (Sn), a second constituent element and a third constituent element is preferable. As a matter of course, this negative electrode material may be used together with the foregoing negative electrode material. The second constituent element is at least one member selected from the group consisting of cobalt (Co), iron (Fe), magnesium (Mg), titanium (Ti), vanadium (V), chromium (Cr), manganese (Mn), nickel (Ni), copper (Cu), zinc (Zn), gallium (Ga), zirconium (Zr), niobium (Nb), molybdenum (Mo), silver (Ag), indium (In), cerium (Ce), hafnium (Hf), tantalum (Ta), tungsten (W), bismuth (Bi), and silicon (Si). The third constituent element is at least one member selected from the group consisting of boron (B), carbon (C), aluminum (Al), and phosphorus (P). This is because when the second constituent element and the third constituent element are contained, a cycle characteristic is enhanced.

Above of all, the negative electrode material is preferably an SnCoC-containing material containing tin (Sn), cobalt (Co), and carbon (C) as constituent elements and having a content of carbon (C) in the range of 9.9% by mass or more and not more than 29.7% by mass and a proportion of cobalt (Co) to the total sum of tin (Sn) and cobalt (Co) (Co/(Sn+Co)) in the range of 30% by mass or more and not more than 70% by mass. This is because in the foregoing composition range, not only a high energy density is obtainable, but an excellent cycle characteristic is obtainable.

This SnCoC-containing material may further contain other constituent elements, if desired. As other constituent elements, for example, silicon (Si), iron (Fe), nickel (Ni), chromium (Cr), indium (In), niobium (Nb), germanium (Ge), titanium (Ti), molybdenum (Mo), aluminum (Al), phosphorus (P), gallium (Ga), and bismuth (Bi) are preferable. The SnCoC-containing material may contain two or more kinds of these elements. This is because a capacity characteristic or a cycle characteristic is more enhanced.

Incidentally, the SnCoC-containing material has a phase containing tin (Sn), cobalt (Co), and carbon (C), and it is preferable that this phase has a lowly crystalline or amorphous structure. Also, in the SnCoC-containing material, it is preferable that at least a part of carbon that is the constituent element is bound to a metal element or a semi-metal element as other constituent element. This is because though it may be considered that a lowering of the cycle characteristic is caused due to aggregation or crystallization of tin (Sn) or the like, when carbon is bound to other element, such aggregation or crystallization is suppressed.

Examples of a measurement method for examining the binding state of elements include X-ray photoelectron spectroscopy (XPS). In this XPS, so far as graphite is concerned, a peak of the 1s orbit (C1s) of carbon appears at 284.5 eV in an energy-calibrated apparatus such that a peak of the 4f orbit of a gold atom (Au4f) is obtained at 84.0 eV. Also, so far as surface contamination carbon is concerned, a peak of the is orbit (C1s) of carbon appears at 284.8 eV. On the contrary, in the case where a charge density of the carbon element is high, for example, in the case where carbon is bound to a metal element or a semi-metal element, the peak of C1s appears in a lower region than 284.5 eV. That is, in the case where a peak of a combined wave of C1s obtained regarding the SnCoC-containing material appears in a lower region than 284.5 eV, at least a part of carbon (C) contained in the SnCoC-containing material is bound to a metal element or a semi-metal element as other constituent element.

Incidentally, in the XPS measurement, for example, the peak of C1s is used for correcting the energy axis of a spectrum. In general, since surface contamination carbon exists on the surface, the peak of C1s of the surface contamination carbon is fixed at 284.8 eV, and this peak is used as an energy reference. In the XPS measurement, since a waveform of the peak of C1s is obtained as a form including the peak of the surface contamination carbon and the peak of carbon in the SnCoC-containing material, the peak of the surface contamination carbon and the peak of the carbon in the SnCoC-containing material are separated from each other by means of analysis using, for example, a commercially available software program. In the analysis of the waveform, the position of a main peak existing on the side of a lowest binding energy is used as an energy reference (284.8 eV).

Also, examples of the negative electrode material capable of intercalating and deintercalating lithium include metal oxides and polymer compounds, each of which is capable of intercalating and deintercalating lithium. Examples of the metal oxide include iron oxide, ruthenium oxide, and molybdenum oxide; and examples of the polymer compound include polyacetylene, polyaniline, and polypyrrole.

Incidentally, the negative electrode material capable of intercalating and deintercalating lithium may also be a material other than those described above. Also, two or more kinds of the above-exemplified negative electrode materials may be mixed in an arbitrary combination.

The negative electrode active material layer 22B may be, for example, formed by any of a vapor phase method, a liquid phase method, a spraying method, a baking method, or a coating method, or a combined method of two or more kinds of these methods. In the case where the negative electrode active material layer 22B is formed by adopting a vapor phase method, a liquid phase method, a spraying method, or a baking method, or a combined method of two or more kinds of these methods, it is preferable that the negative electrode active material layer 22B and the negative electrode collector 22A are alloyed on at least a part of an interface therebetween. Specifically, it is preferable that on the interface, the constituent elements of the negative electrode collector 22A are diffused into the negative electrode active material layer 22B, the constituent elements of the negative electrode active material layer 22B are diffused into the negative electrode collector 22A, or these constituent elements are mutually diffused into each other. This is because not only breakage to be caused due to expansion and shrinkage of the negative electrode active material layer 22B following the charge and discharge can be suppressed, but electron conductivity between the negative electrode active material layer 22B and the negative electrode collector 22A can be enhanced.

Incidentally, examples of the vapor phase method include a physical deposition method and a chemical deposition method, specifically a vacuum vapor deposition method, a sputtering method, an ion plating method, a laser abrasion method, a thermal chemical vapor deposition (CVD) method, and a plasma chemical vapor deposition method. As the liquid phase method, known techniques such as electroplating and non-electrolytic plating can be adopted. The baking method as referred to herein is, for example, a method in which after a granular negative electrode active material is mixed with a binder and the like, the mixture is dispersed in a solvent and coated, and the coated material is then heat treated at a higher temperature than a melting point of the binder, etc. As to the baking method, known techniques can be utilized, too, and examples thereof include an atmospheric baking method, a reaction baking method, and a hot press baking method.

### (Separator)

The separator 23 partitions the positive electrode 21 and the negative electrode 22 from each other and allows a lithium ion to pass therethrough while preventing a short circuit of the current to be cause due to the contact between the both electrodes. This separator 23 is constituted of, for example, a porous film made of a synthetic resin such as polytetrafluoroethylene, polypropylene, and polyethylene; a porous film made of a ceramic; or the like, and a laminate of two or more kinds of these porous films may also be used. This separator 23 is impregnated with an electrolytic solution that is a liquid electrolyte.

### (Electrolytic Solution)

The electrolytic solution contains a solvent, an electrolyte salt dissolved in this solvent, and a compound represented by the following general formula (I). This electrolytic solution is a liquid electrolyte and is, for example, a nonaqueous electrolytic solution having an electrolyte salt in a nonaqueous solvent.

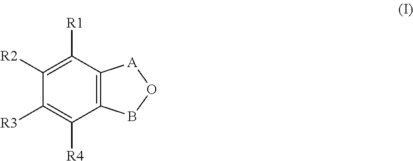

In the general formula (I), each of R1 to R4 independently represents a group having a hydrocarbon group having at least one aromatic ring and at least one unsaturated bond or a hydrogen atom, provided that at least one of R1 to R4 is a group having a hydrocarbon group having at least one aromatic ring and at least one unsaturated bond; and each of A and B independently represents a carbonyl group, a sulfonyl group, or a methylene group, provided that at least one of A and B is a carbonyl group or a sulfonyl group.

The compound represented by the general formula (I) is a compound in which at least one of hydrogens of a parent compound of the compound of the general formula (I) (a compound of the general formula (I) wherein all of R1 to R4 are a hydrogen atom) is substituted with a group having a hydrocarbon group having at least one aromatic ring and at least one unsaturated bond (this group will be hereunder sometimes referred to as “substituent R” for the sake of convenience of explanation).

According to the embodiment of the present disclosure, by allowing the electrolytic solution to contain the compound represented by the general formula (1), since a side reaction of the electrode active material and the electrolytic solution is suppressed at the time of high-temperature storage, deterioration of the capacity at the time of high-temperature storage can be suppressed.

It may be considered that the effects in the case of adding the compound of the general formula (I) to the electrolytic solution are brought due to the fact that the substituent R which the compound of the general formula (I) has and the parent compound decompose together at the time of initial charge, whereby SEI (solid electrolyte interface) generated on the negative electrode takes a stable structure.

It is conjectured that an acid anhydride derivative (the compound of the general formula (I)) decomposes (in more detail, a segment of the compound of the general formula (I) exclusive of the substituent R preferentially decomposes over the decomposition of an unsaturated bond which the substituent R has) and adsorbs onto the surface of the negative electrode, and furthermore, the substituent having an unsaturated bond (substituent R) is polymerized, whereby firm SEI is formed, and it may be considered that the side reaction in the case of storing the battery at a high temperature can be suppressed. Incidentally, in detail, as will be described in the “EXAMPLES”, in view of the fact that even when a compound analogous to the substituent R and the substituent-free parent compound were mixed and contained in a nonaqueous electrolyte, effects of the same degree as that in the case of containing the compound represented by the general formula (I) were not obtained, it is conjectured that the matter that the substituent R and the parent compound of the general formula (I) are connected to each other as represented by the general formula (I) is an important factor.

In the general formula (I), the group having a hydrocarbon group having at least one aromatic ring and at least one unsaturated bond (the substituent R) is preferably a group having a hydrocarbon group having at least one aromatic ring and at least one unsaturated bond located at a position other than an end thereof. This is because in the case where an unsaturated bond is located at an end of the substituent R relative to the parent compound, decomposition of the unsaturated bond preferentially occurs, so that the effects tend to become small.

More specifically, examples of the substituent R include substituents represented by the following general formulae (II) to (III).

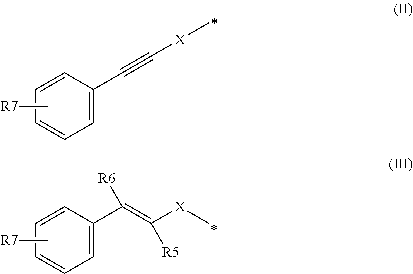

R5, R6, R7, X, and * in the general formulae (II) and (III) are hereunder described.

Each of R5 and R6 in the general formula (III) independently represents a hydrogen atom or a hydrocarbon group. R7 in the general formulae (II) and (III) represents a substituent bound to the aromatic ring. Examples of R7 include HO—, F—, CH₃—, CF₃—, C₆H₅—, C₆H₄F—, CN—, CH₃O—, HOC(═O)—, CH₃C(═O)—, CH₃C(═O)O—, CH₃OC(═O)O—, HS—, CH₃S—, CH₃S(═O)—, CH₃S(═O)₃—, CH₃S(═O)₂O—, CH₃OS(═O)₂—, CH₃OS(═O)₂O—, (CH₃O)₂P(═O)O—, (CH₃O)₂BO—, (CH₃)₂NC(═O)—, CH₃C(═O)N(CH₃)—, and (HO)C(CF₃)₂C₆H₅—.

X in the general formulae (II) and (III) represents a connecting group between the unsaturated bond bound to the aromatic ring and the parent compound. Specifically, X is, for example, an organic group having a substituent selected from the group consisting of an alkyl group (—CₙHₘ— (each of n and m represents an integer), which may contain a phenyl group or an unsaturated bond), an oxy group (—O—), a carbonyl group (—C(═O)—)), a carbonate group (—OC(═O)O—), a sulfide group (—S—), a sulfinyl group (—S(═O)—), a sulfonyl group (—S(═O)₂—), a sulfonyloxy group (—OS(═O)₂—), a sulfite group (—OS(═O)O—), a sulfate group (—OS(═O)₂O—), and a phosphate group (—O(HO)P(═O)O—). Incidentally, this organic group may contain a plurality of the foregoing substituents. The * mark in the general formulae (II) and (III) expresses a point connecting to the parent compound of the general formula (I).

Specific examples of the substituent represented by the general formula (II) include a group of substituents of the following Substituents A to O, and these substituents are preferable. Incidentally, the * mark in the formulae expresses a point connecting to the parent compound.

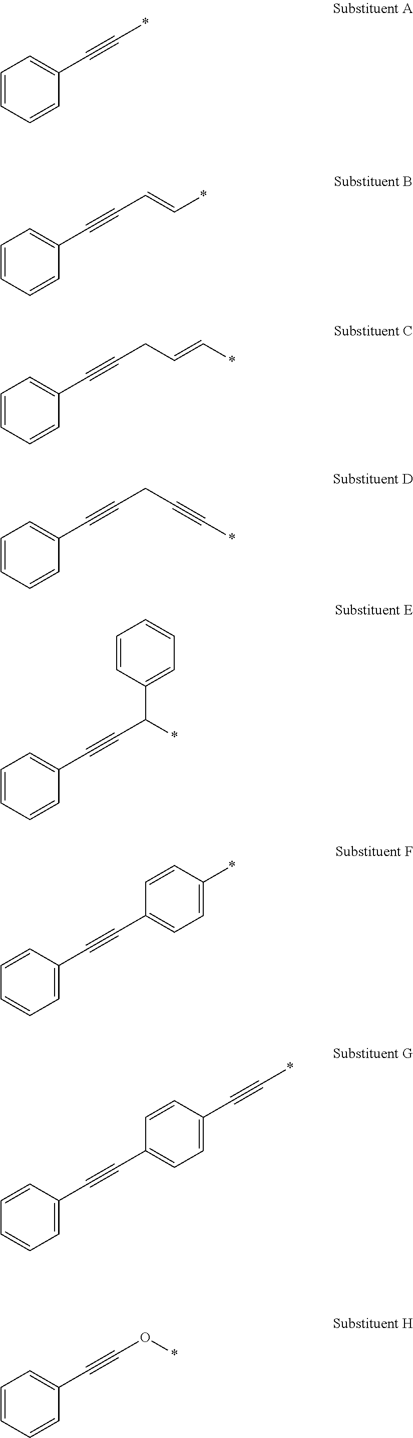

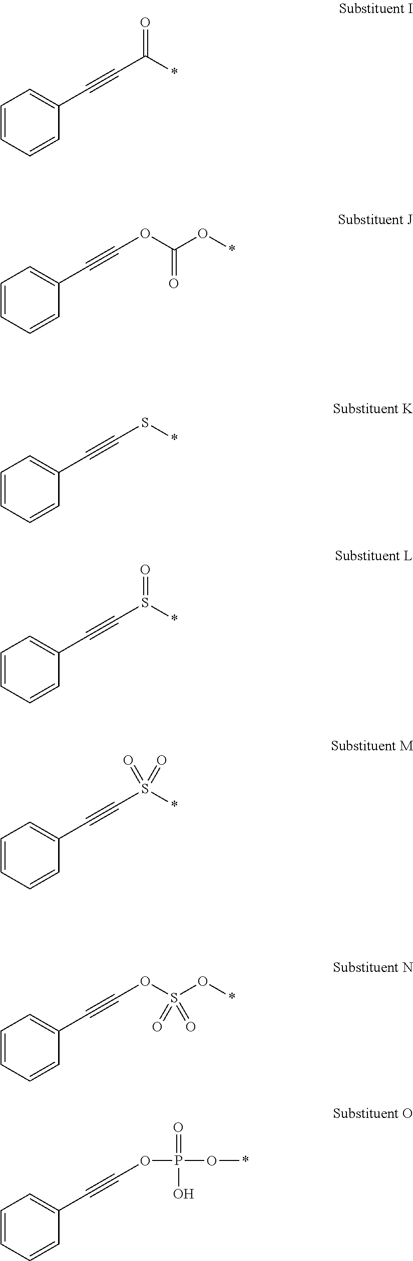

Specific examples of the substituent represented by the general formula (III) include a group of substituents of the following Substituents A′ to O′.

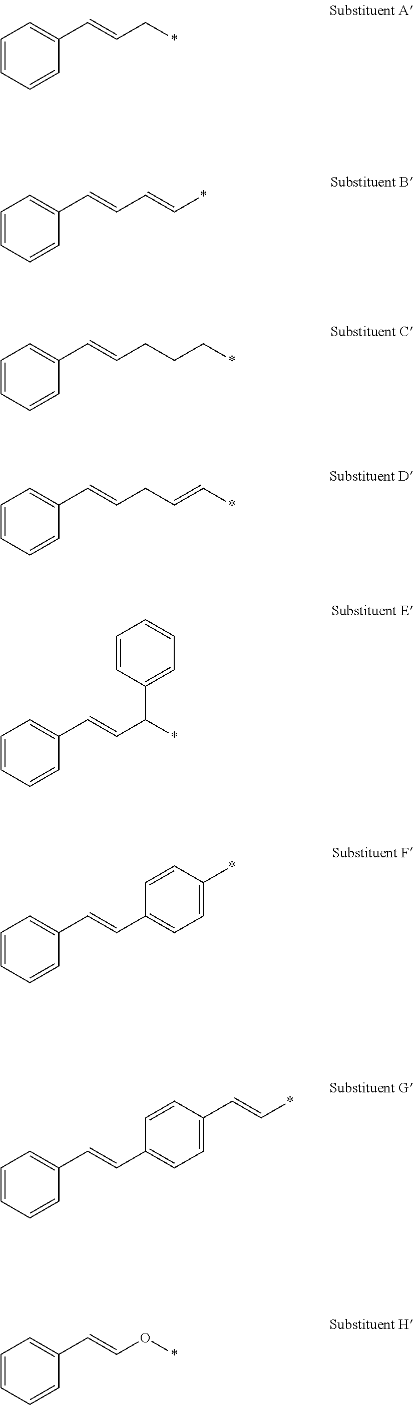

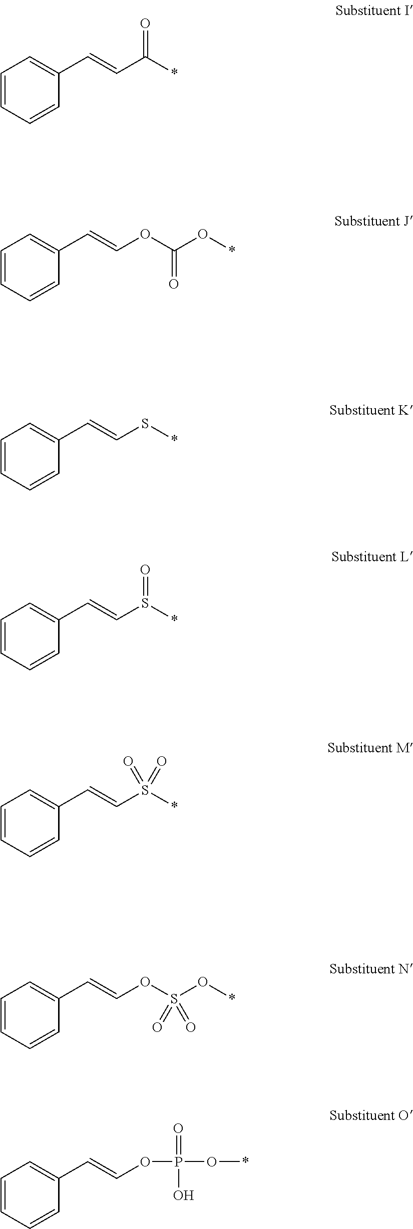

Specific examples of the parent compound of the compound represented by the general formula (I) include phthalic anhydride, phthalide, 2-sulfobenzoic acid, α-hydroxy-o-toluenesulfonic acid γ-sulfone, and benzene-1,2-disulfonic anhydride. Specific examples of the compound represented by the general formula (I) that is a derivative of such a parent compound include compounds represented by the following general formulae (I-1) to (I-5).

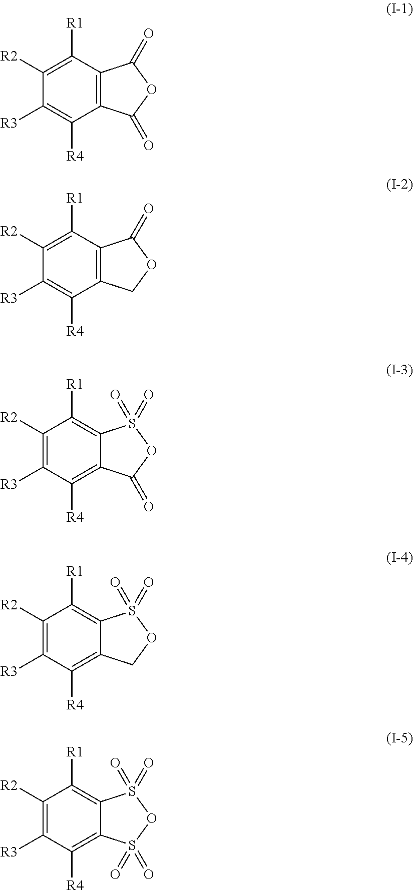

R1 to R4 in the general formulae (I-1) to (I-5) are synonymous with R1 to R4 in the general formula (I). That is, each of R1 to R4 independently represents a group having a hydrocarbon group having at least one aromatic ring and at least one unsaturated bond or a hydrogen atom, provided that at least one of R1 to R4 is a group having a hydrocarbon group having at least one aromatic ring and at least one unsaturated bond.

A form of the use of the foregoing compound is not particularly limited by the composition of the electrolytic solution or the kinds of the positive electrode and the negative electrodes. Also, even when an electrolytic solution additive other than the foregoing compound is added to the electrolytic solution, the effects to be brought due to the fact that the foregoing compound is allowed to contain in the electrolytic solution are not impaired. For example, when the compound of the foregoing general formula (I) is used together with an unsaturated carbonate or a halogenated carbonate as described later, in addition to an effect to be brought due to the fact that the unsaturated carbonate or halogenated carbonate is allowed to contain, the effects to be brought due to the fact that the foregoing compound is allowed to contain can be additively obtained.

### (Content)

From the standpoint that more excellent effects are obtained, a content of this compound is preferably 0.01% by mass or more and not more than 5.0% by mass, and more preferably 0.01% by mass or more and not more than 1.0% by mass.

### (Solvent)

Examples of the solvent include nonaqueous solvents such as ethylene carbonate (EC), propylene carbonate, butylene carbonate, dimethyl carbonate (DMC), diethyl carbonate, ethyl methyl carbonate, methyl propyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethylacetate, ethyl trimethylacetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide.

These exemplified solvents may be used singly, or may be properly combined and used in admixture of two or more kinds thereof. Of these solvent, at least one member selected from the group consisting of ethylene carbonate, propylene carbonate, dimethyl carbonate, diethyl carbonate, and ethyl methyl carbonate is preferable. In that case, a combination of a high viscosity (high dielectric constant) solvent (for example, specific dielectric constant ∈≧30), such as ethylene carbonate and propylene carbonate, and a low viscosity solvent (for example, viscosity≦1 mPa·s), such as dimethyl carbonate, ethyl methyl carbonate, and diethyl carbonate, is more preferable. This is because dissociation properties of the electrolyte salt and mobility of ions are enhanced.

### (Unsaturated or Halogenated Carbonate)

It is preferable that the electrolytic solution contains a halogenated carbonate or an unsaturated carbonate together with the compound represented by the general formula (I).

### (Halogenated Carbonate)

The halogenated carbonate is a halogen-containing carbonate. In view of the fact that the electrolytic solution contains the halogenated carbonate, a stable protective film is formed on the surface of the electrode at the time of electrode reaction, so that a decomposition reaction of the electrolytic solution is suppressed. Examples of such a halogenated carbonate include a halogenated chain carbonate represented by the following general formula (IV) and a halogenated cyclic carbonate represented by the following general formula (V).

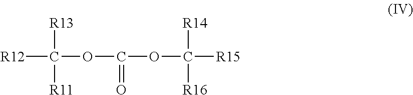

In the general formula (IV), each of R11 to R16 independently represents a hydrogen atom, a halogen atom, an alkyl group, or a halogenated alkyl group, provided that at least one of R11 to R16 is a halogen atom or a halogenated alkyl group.

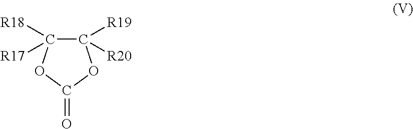

In the general formula (V), each of R17 to R20 independently represents a hydrogen atom, a halogen atom, an alkyl group, or a halogenated alkyl group, provided that at least one of R17 to R20 is a halogen atom or a halogenated alkyl group.

Specific examples of the halogenated chain carbonate represented by the general formula (IV) include fluoromethyl carbonate (FDMC) and bis(fluoromethyl) carbonate (DFDMC).

Specific examples of the halogenated cyclic carbonate represented by the general formula (V) include 4-fluoro-1,3-dioxolan-2-one (FEC) and 4,5-difluoro-1,3-dioxolan-2-one (DFEC).

### (Unsaturated Carbonate)

The unsaturated carbonate is an unsaturated bond-containing carbonate. In view of the fact that the electrolytic solution contains the unsaturated carbonate, a stable protective film is formed on the surface of the electrode at the time of electrode reaction, so that a decomposition reaction of the electrolytic solution is suppressed. Examples of such an unsaturated carbonate include unsaturated cyclic carbonates represented by the following general formulae (VI) to (VIII).

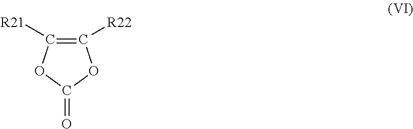

In the general formula (VI), each of R21 and R22 independently represents a hydrogen atom, a halogen atom, an alkyl group, or a halogenated alkyl group.

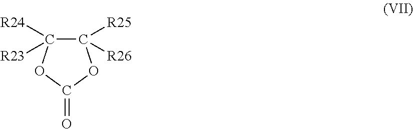

In the general formula (VII), each of R23 to R26 independently represents a hydrogen atom, an alkyl group, a vinyl group, or an allyl group, provided that at least one of R23 to R26 is a vinyl group or an allyl group.

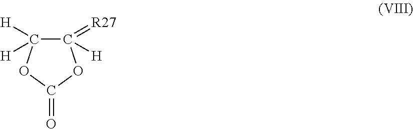

In the general formula (VIII), R27 represents an alkylene group.

The unsaturated cyclic carbonate represented by the general formula (VI) is a vinylene carbonate based compound. Examples of this vinylene carbonate based compound include vinylene carbonate, methyl vinylene carbonate, and ethyl vinylene carbonate. Also, examples thereof includes 4,5-dimethyl-1,3-dioxol-2-one, 4,5-diethyl-1,3-dioxol-2-one, 4-fluoro-1,3-dioxol-2-one, and 4-trifluoromethyl-1,3-dioxol-2-one. Of these, vinylene carbonate is preferable. This is because not only this material is easily available, but high effects are obtainable.

The unsaturated cyclic carbonate represented by the general formula (VII) is a vinylene ethylene carbonate based compound. Examples of this vinylene ethylene carbonate based compound include vinyl ethylene carbonate, 4-methyl-4-vinyl-1,3-dioxolan-2-one, or 4-ethyl-4-vinyl-1,3-dioxolan-2-one. Also, examples thereof include 4-n-propyl-4-vinyl-1,3-dioxolan-2-one, 5-methyl-4-vinyl-1,3-dioxolan-2-one, 4,4-divinyl-1,3-dioxolan-2-one, or 4,5-divinyl-1,3-dioxolan-2-one. Of these, vinyl ethylene carbonate is preferable. This is because not only this material is easily available, but high effects are obtainable. As a matter of course, as to R23 to R26, all of them may be a vinyl group or an allyl group, or a vinyl group and an allyl group may be mixed together.

The unsaturated cyclic carbonate represented by the general formula (VIII) is a methylene ethylene carbonate based compound. Examples of this methylene ethylene carbonate based compound include 4-methylene-1,3-dioxolan-2-one, 4,4-dimethyl-5-methylene-1,3-dioxolan-2-one, or 4,4-diethyl-5-methylene-1,3-dioxolan-2-one. This methylene ethylene carbonate based compound may also be a compound having two methylene groups in addition to a compound having one methylene group (the compound represented by the general formula (VIII)).

Incidentally, the unsaturated carbonate may be a catechol carbonate having a benzene ring, or the like.

### (Electrolyte Salt)

As the electrolyte salt, for example, one or two or more kinds of light metal salts such as a lithium salt can be used.

Examples of the lithium salt include lithium hexafluorophosphate (LiPF₆), lithium tetrafluoroborate, lithium perchlorate, lithium hexafluoroarsenate, lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). Incidentally, these exemplified electrolyte salts may be properly combined and used.

### (Manufacturing Method of Battery)

This nonaqueous electrolyte battery is, for example, manufactured by the following manufacturing method.

### (Manufacture of Positive Electrode)

First of all, the positive electrode 21 is fabricated. A positive electrode active material, a binder, and a conductive agent are first mixed to form a positive electrode mixture, which is then dispersed in an organic solvent to form a positive electrode mixture slurry in a paste form. Subsequently, the positive electrode mixture slurry is uniformly coated on the both surfaces of the positive electrode collector 21A by a doctor blade, a bar coater, or the like and then dried. Finally, the coating is subjected to compression molding by a roll press or the like while heating, if desired, thereby forming the positive electrode active material layer 21B. In that case, the compression molding may be repeatedly carried out plural times.

### (Manufacture of Negative Electrode)

Next, the negative electrode 22 is fabricated. A negative electrode material and a binder, and optionally, a conductive agent are first mixed to form a negative electrode mixture, which is then dispersed in an organic solvent to form a negative electrode mixture slurry in a paste form. Subsequently, the negative electrode mixture slurry is uniformly coated on the both surfaces of the negative electrode collector 22A by a doctor blade, a bar coater, or the like and then dried. Finally, the coating is subjected to compression molding by a roll press or the like while heating, if desired, thereby forming the negative electrode active material layer 22B.

Incidentally, the negative electrode 22 may also be fabricated in the following manner. The negative electrode collector 22A made of an electrolytic copper foil or the like is first prepared, and a negative electrode material is then deposited on the both surfaces of the electrode collector 22A by a vapor phase method such as a vapor deposition method, thereby forming plural negative electrode active material particles. Thereafter, if desired, an oxide-containing film is formed by a liquid phase method such as a liquid phase deposition method, or a metal material is formed by a liquid phase method such as an electrolytic plating method, or the both are formed, thereby forming the negative electrode active material layer 22B.

### (Assembling of Battery)

Assembling of the nonaqueous electrolyte battery is carried out in the following manner. First of all, a positive electrode lead 25 is installed in the positive electrode collector 21A by means of welding or the like, and a negative electrode lead 26 is also installed in the negative electrode collector 22A by means of welding or the like. Subsequently, the positive electrode 21 and the negative electrode 22 are laminated via the separator 23 and wound to fabricate the wound electrode body 20, and a center pin 24 is then inserted into the winding center thereof. Subsequently, the wound electrode body 20 is housed in the inside of the battery can 11 while being interposed between a pair of the insulating plates 12 and 13; and a tip portion of the positive electrode lead 25 is welded to a safety valve mechanism 15, whereas a tip portion of the negative electrode lead 26 is welded to the battery can 11.

Subsequently, the foregoing electrolytic solution is injected into the inside of the battery can 11 and impregnated in the separator 23. Finally, a battery lid 14, the safety valve mechanism 15, and a positive temperature coefficient device 16 are fixed to the open end portion of the battery can 11 upon being caulked via a gasket 17. There is thus completed the nonaqueous electrolyte battery shown in FIGS. 1 and 2.

### 2. Second Embodiment

### Configuration of Battery

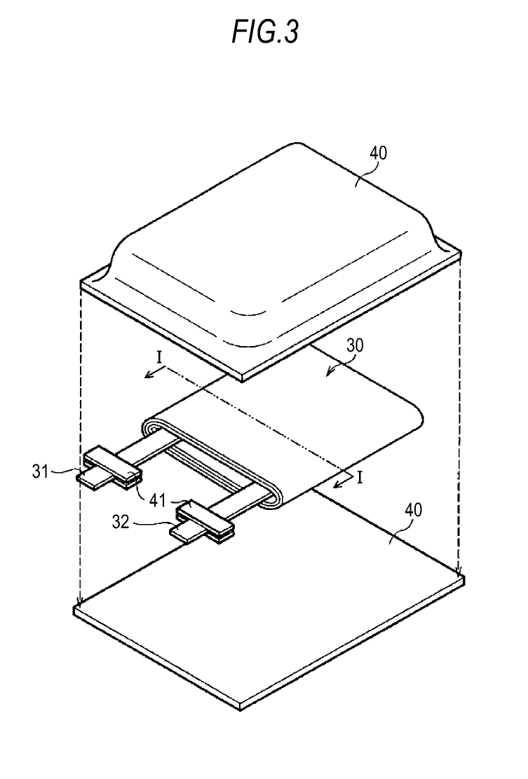

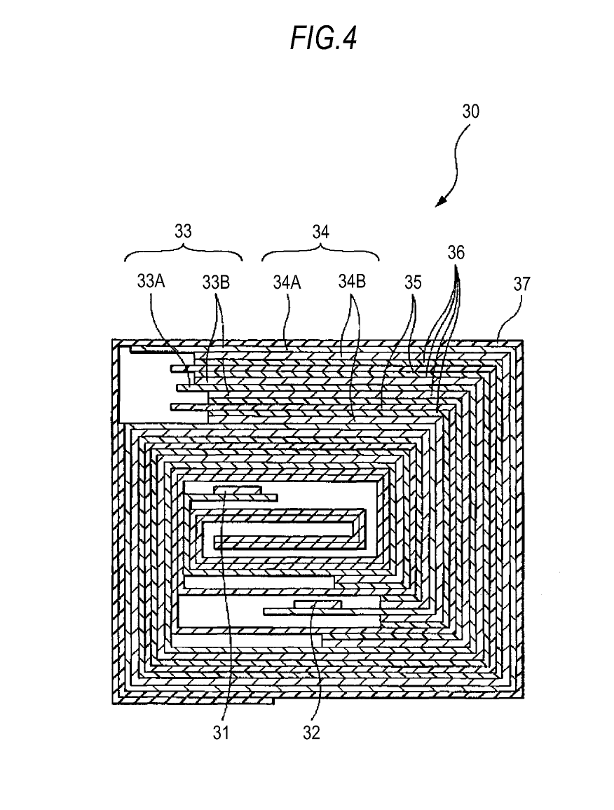

A nonaqueous electrolyte battery according to a second embodiment of the present disclosure is described. FIG. 3 expresses an exploded perspective configuration of a nonaqueous electrolyte battery according to the second embodiment of the present disclosure; and FIG. 4 enlargedly shows a section along an I-I line of a wound electrode body 30 shown in FIG. 3.

This nonaqueous electrolyte battery is chiefly a nonaqueous electrolyte battery in which the wound electrode body 30 having a positive electrode lead 31 and a negative electrode lead 32 installed therein is housed in the inside of a package member 40 in a film form. The battery structure using this package member 40 in a film form is called a laminated film type.

The positive electrode lead 31 and the negative electrode lead 32 are each led out in, for example, the same direction from the inside toward the outside of the package member 40. The positive electrode lead 31 is, for example, constituted of a metal material such as aluminum, and the negative electrode lead 32 is, for example, constituted of a metal material such as copper, nickel, and stainless steel. Such a metal material is, for example, formed in a thin plate state or a network state.

The package member 40 is, for example, constituted of an aluminum laminated film obtained by sticking a nylon film, an aluminum foil, and a polyethylene film in this order. For example, this package member 40 has a structure in which respective outer edges of the two rectangular aluminum laminated films are allowed to adhere to each other by means of fusion or with an adhesive in such a manner that the polyethylene film is disposed opposing to the wound electrode body 30.

A contact film 41 is inserted between the package member 40 and each of the positive electrode lead 31 and the negative electrode lead 32 for the purpose of preventing invasion of the outside air from occurring. This contact film 41 is constituted of a material having adhesion to each of the positive electrode lead 31 and the negative electrode lead 32. Examples of such a material include polyolefin resins such as polyethylene, polypropylene, modified polyethylene, and modified polypropylene.

Incidentally, the package member 40 may also be constituted of a laminated film having other lamination structure, or constituted of a polymer film such as polypropylene or a metal film, in place of the foregoing aluminum laminated film.

FIG. 4 shows a sectional configuration along an I-I line of the wound electrode body 30 shown in FIG. 3. This wound electrode body 30 is a wound electrode body prepared by laminating a positive electrode 33 and a negative electrode 34 via a separator 35 and an electrolyte 36 and winding the laminate, and an outermost peripheral part thereof is protected by a protective tape 37.

The positive electrode 33 is, for example, a positive electrode in which a positive electrode active material layer 33B is provided on the both surfaces of a positive electrode collector 33A. The negative electrode 34 is, for example, a negative electrode in which a negative electrode active material layer 34B is provided on the both surfaces of a negative electrode collector 34A, and the negative electrode active material layer 34B is disposed opposing to the positive electrode active material layer 33B. The configurations of the positive electrode collector 33A, the positive electrode active material layer 33B, the negative electrode collector 34A, the negative electrode active material layer 34B, and the separator 35 are the same as those of the positive electrode collector 21A, the positive electrode active material layer 21B, the negative electrode collector 22A, the negative electrode active material layer 22B, and the separator 23 in the first embodiment, respectively.

The electrolyte 36 is an electrolyte in a so-called gel form, which contains the same electrolytic solution as that in the foregoing first embodiment and a polymer compound for holding it therein. The electrolyte in a gel form is preferable because not only a high ion conductivity (for example, 1 mS/cm or more at room temperature) is obtainable, but the liquid leakage is prevented from occurring.

Examples of the polymer compound include polyacrylonitrile, polyvinylidene fluoride, a copolymer of polyvinylidene fluoride and polyhexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, a styrene-butadiene rubber, a nitrile-butadiene rubber, polystyrene, and polycarbonate. These materials may be used singly or in admixture of plural kinds thereof. Of these, polyacrylonitrile, polyvinylidene fluoride, polyhexafluoropropylene, and polyethylene oxide are preferable because these materials are electrochemically stable.

### (Manufacturing Method of Battery)

This nonaqueous electrolyte battery is, for example, manufactured by any of the following three kinds of manufacturing methods (first to third manufacturing methods).

### (First Manufacturing Method)

In a first manufacturing method, first of all, for example, the positive electrode active material layer 33B is formed on the both surfaces of the positive electrode collector 33A by the same fabrication procedures as those of the positive electrode 21 and the negative electrode 22 according to the foregoing first embodiment, thereby fabricating the positive electrode 33. Also, the negative electrode active material layer 34B is formed on the both surfaces of the negative electrode collector 34A, thereby fabricating the negative electrode 34.

Subsequently, a precursor solution containing an electrolytic solution the same as that in the foregoing first embodiment, a polymer compound, and a solvent is prepared and coated on each of the positive electrode 33 and the negative electrode 34, and the solvent is then vaporized to form the electrolyte 36 in a gel form. Subsequently, the positive electrode lead 31 is installed in the positive electrode collector 33A, and the negative electrode lead 32 is also installed in the negative electrode collector 34A.

Subsequently, the positive electrode 33 and the negative electrode 34 each having the electrolyte 36 formed therein are laminated via the separator 35, the laminate is then wound in a longitudinal direction thereof, and the protective tape 37 is allowed to adhere to an outermost peripheral part thereof, thereby fabricating the wound electrode body 30. Finally, for example, the wound electrode body 30 is interposed between the two package members 40 in a film form, and the outer edges of the package members 40 are allowed to adhere to each other by means of heat fusion or the like, thereby sealing the wound electrode body 30 therein. On that occasion, the contact film 41 is inserted between each of the positive electrode lead 31 and the negative electrode lead 32 and the package member 40. There is thus completed the nonaqueous electrolyte battery shown in FIGS. 3 and 4.

### (Second Manufacturing Method)

In a second manufacturing method, first of all, the positive electrode lead 31 is installed in the positive electrode 33, and the negative electrode lead 32 is also installed in the negative electrode 34. Subsequently, the positive electrode 33 and the negative electrode 34 are laminated via the separator 35 and wound, and the protective tape 37 is then allowed to adhere to an outermost peripheral part of the resulting laminate, thereby fabricating a wound body serving as a precursor of the wound electrode body 30.

Subsequently, the wound body is interposed between the two package members 40 in a film form, and the outer edges exclusive of one side are allowed to adhere to each other by means of heat fusion or the like, thereby housing the wound body in the inside of the package member 40 in a bag form. Subsequently, an electrolyte composition containing the electrolytic solution according to the first embodiment, a monomer that is a raw material of the polymer compound, and a polymerization initiator, and optionally, other material such as a polymerization inhibitor is prepared and injected into the inside of the package member 40 in a bag form. Thereafter, an opening of the package member 40 is hermetically sealed by means of heat fusion or the like. Finally, the monomer is heat polymerized to form a polymer compound, thereby forming the electrolyte 36 in a gel form. There is thus completed the nonaqueous electrolyte battery shown in FIGS. 3 and 4.

### (Third Manufacturing Method)

In a third manufacturing method, first of all, a wound body is formed and housed in the inside of the package member 40 in a bag form in the same manner as that in the foregoing second manufacturing method, except for using the separator 35 having a polymer compound formed on the both surfaces thereof.

Examples of the polymer compound which is coated on this separator 35 include polymers composed of, as a component, vinylidene fluoride, namely a homopolymer, a copolymer, a multi-component copolymer, or the like. Specific examples thereof include polyvinylidene fluoride; a binary copolymer composed of, as components, vinylidene fluoride and hexafluoropropylene; and a ternary copolymer composed of, as components, vinylidene fluoride, hexafluoropropylene, and chlorotrifluoroethylene.

Incidentally, the polymer compound may contain one or two or more kinds of other polymer compound together with the foregoing polymer composed of, as a component, vinylidene fluoride. Subsequently, the electrolytic solution according to the first embodiment is prepared and injected into the inside of the package member 40, and an opening of the package member 40 is then hermetically sealed by means of heat fusion or the like. Finally, the separator 35 is brought into intimate contact with each of the positive electrode 33 and the negative electrode 34 via the polymer compound upon heating while adding a weight to the package member 40. According to this, the electrolytic solution is impregnated into the polymer compound, and the polymer compound is gelled to form the electrolyte 36. There is thus completed the nonaqueous electrolyte battery shown in FIGS. 3 and 4.

### 3. Third Embodiment

A nonaqueous electrolyte battery according to a third embodiment of the present disclosure is described. The nonaqueous electrolyte battery according to the third embodiment of the present disclosure is the same as the nonaqueous electrolyte battery according to the second embodiment, except that the electrolytic solution is used as it is, in place of the electrolytic solution held on a polymer compound (the electrolyte 36). In consequence, its configuration is hereunder described in detail centering on points which are different from those in the second embodiment.

### (Configuration of Battery)

In the nonaqueous electrolyte battery according to the third embodiment of the present disclosure, an electrolytic solution is used in place of the electrolyte 36 in a gel form. In consequence, the wound electrode body 30 has a configuration in which the electrolyte 36 is omitted, and an electrolytic solution the same as that in the first embodiment is impregnated in the separator 35.

### (Manufacturing Method of Battery)

This nonaqueous electrolyte battery is, for example, manufactured in the following manner.

First all, for example, a positive electrode active material, a binder, and a conductive agent are mixed to prepare a positive electrode mixture, which is then dispersed in a solvent such as N-methyl-2-pyrrolidone to prepare a positive electrode mixture slurry. Subsequently, this positive electrode mixture slurry is coated on the both surfaces of the positive electrode collector 33A, dried, and then compression molded to form the positive electrode active material layer 33B, thereby fabricating the positive electrode 33. Subsequently, for example, the positive electrode lead 31 is joined to the positive electrode collector 33A by means of, for example, ultrasonic welding, spot welding, etc.

Also, for example, a negative electrode material and a binder are mixed to prepare a negative electrode mixture, which is then dispersed in a solvent such as N-methyl-2-pyrrolidone to prepare a negative electrode mixture slurry. Subsequently, this negative electrode mixture slurry is coated on the both surfaces of the negative electrode collector 34A, dried, and then compression molded to form the negative electrode active material layer 34B, thereby fabricating the negative electrode 34. Subsequently, for example, the negative electrode lead 32 is joined to the negative electrode collector 34A by means of, for example, ultrasonic welding, spot welding, etc.

Subsequently, the positive electrode 33 and the negative electrode 34 are wound via the separator 35 and interposed in the inside of the package member 40, and an electrolytic solution the same as that in the first embodiment is then injected into the inside of the package member 40, followed by hermetically sealing the package member 40. There is thus obtained the nonaqueous electrolyte battery shown in FIGS. 3 and 4.

### 4. Fourth Embodiment

### Example of Battery Pack

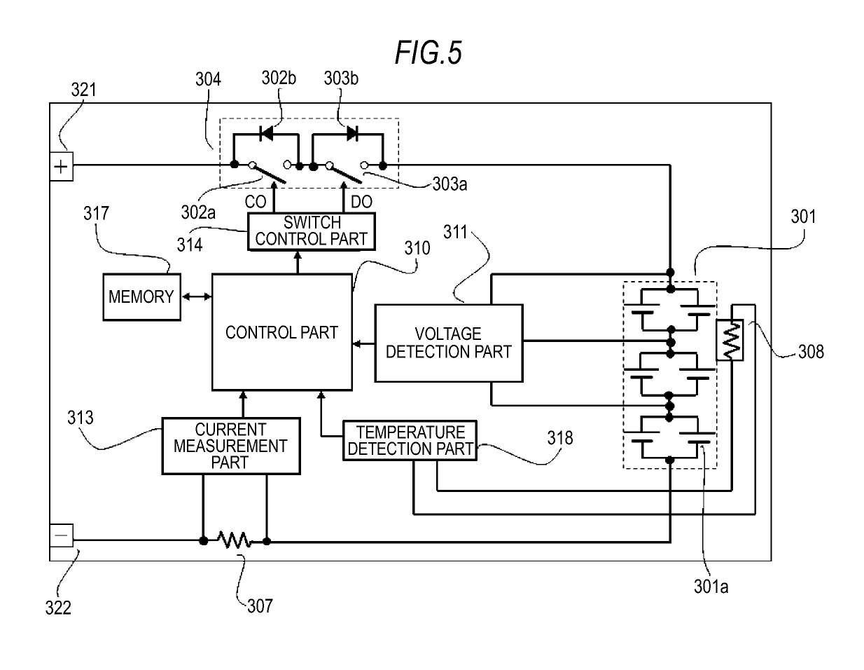

FIG. 5 is a block diagram showing an example of a circuit configuration in the case where the nonaqueous electrolyte battery of the embodiment of the present disclosure (hereinafter referred to properly as “secondary battery”) is applied to a battery pack. The battery pack includes an assembled battery 301, a package, a switch part 304 provided with a charge control switch 302a and a discharge control switch 303a, a current detection resistor 307, a temperature detection device 308, and a control part 310.

Also, the battery pack includes a positive electrode terminal 321 and a negative electrode terminal 322, and at the time of charge, the positive electrode terminal 321 and the negative electrode terminal 322 are connected to a positive electrode terminal and a negative electrode terminal of a battery charger, respectively, whereby charge is carried out. Also, at the time of using an electronic appliance, the positive electrode terminal 321 and the negative electrode terminal 322 are connected to a positive electrode terminal and a negative electrode terminal of the electronic appliance, respectively, whereby discharge is carried out.

In the assembled battery 301, a plurality of secondary batteries 301a are connected in series and/or in parallel. This secondary battery 301a is the secondary battery of the embodiment of the present disclosure. Incidentally, in FIG. 5, though the case where six secondary batteries 301a are connected to each other, two in parallel and three in series (2P3S) is shown, besides, any connection method such as n in parallel and m in series (each of n and m is an integer) may be adopted.

The switch part 304 includes the charge control switch 302a and a diode 302b and also the discharge control switch 303a and a diode 303b, and is controlled by the control part 310. The diode 302b has a polarity of the reverse direction against a charge current flowing in the direction from the positive electrode terminal 321 to the assembled battery 301 and of the forward direction against a discharge current flowing in the direction from the negative terminal 322 to the assembled battery 301. The diode 303b has a polarity of the forward direction against the charge current and of the reverse direction against the discharge current. Incidentally, in this example, though the switch part is provided on the “+” side, it may also be provided on the “−” side.

In the case where the battery voltage becomes an overcharge detection voltage, the charge control switch 302a is turned off and controlled by a charge and discharge control part in such a manner that the charge current does not flow into a current path of the assembled battery 301. After the charge control switch 302a is turned off, it becomes possible to perform only discharge by going through the diode 302b. Also, in the case where a large current flows at the time of charge, the charge control switch 302a is turned off and controlled by the control part 310 in such a manner that the charge current which flows into the current path of the assembled battery 301 is interrupted.

In the case where the battery voltage becomes an overdischarge detection voltage, the discharge control switch 303a is turned off and controlled by the control part 310 in such a manner that the discharge current does not flow into the current path of the assembled battery 301. After the discharge control switch 303a is turned off, it becomes possible to perform only charge by going through the diode 303b. Also, in the case where a large current flows at the time of discharge, the discharge control switch 303a is turned off and controlled by the control part 310 in such a manner that the discharge current which flows into the current path of the assembled battery 301 is interrupted.

The temperature detection device 308 is, for example, a thermistor and is provided in the vicinity of the assembled battery 301, and it measures a temperature of the assembled battery 301 and supplies the measured temperature to the control part 310. A voltage detection part 311 measures voltages of the assembled battery 301 and the respective secondary batteries 301a constituting the assembled battery 301, and it A/D converts this measured voltage and supplies the converted voltage to the control part 310. A current measurement part 313 measures the current by using the current detection resistor 307 and supplies this measured current to the control part 310.

A switch control part 314 controls the charge control switch 302a and the discharge control switch 303a of the switch part 304 on the basis of the voltage and the current inputted from the voltage detection part 311 and the current measurement part 313, respectively. When the voltage of any one of the secondary batteries 301a becomes not more than an overcharge detection voltage or an overdischarge detection voltage, or a large current suddenly flows, the switch control part 314 sends a control signal to the switch part 304, thereby preventing overcharge or overdischarge, or overcurrent charge and discharge from occurring.

Here, for example, in the case where the secondary battery is a lithium ion secondary battery, the overcharge detection voltage is, for example, determined as 4.20 V±0.05 V, and the overdischarge detection voltage is, for example, determined as 2.4 V±0.1 V.

As the charge and discharge switch, a semiconductor switch, for example, MOSFET, etc., can be used. In that case, a parasitic diode of MOSFET functions as the diodes 302b and 303b. In the case where a P-channel type FET is used as the charge and discharge switch, the switch control part 314 supplies control signals DO and CO to respective gates of the charge control switch 302a and the discharge control switch 303a, respectively. In the case of the P-channel type, the charge control switch 302a and the discharge control switch 303a are turned on by a gate potential lower by a prescribed value or more than a source potential. That is, in the usual charge and discharge operations, the charge control switch 302a and the discharge control switch 303a are turned in the ON state while taking the control signals CO and DO as low levels.

Then, for example, on the occasion of overcharge or overdischarge, the charge control switch 302a and the discharge control switch 303a are turned in the OFF state while taking the control signals CO and DO as high levels.

A memory 317 is composed of RAM or ROM and is, for example, composed of EPROM (erasable programmable read only memory) that is a non-volatile memory, or the like. The memory 317 previously stores numerical values calculated by the control part 310, an inner battery resistance value of the respective secondary battery 301a in an initial state measured at the stage of a manufacturing step, and so on. Also, it is possible to properly achieve rewriting. Also, by allowing the memory 317 to store a complete charge capacity of the secondary battery 301a, the memory 317 is able to calculate, for example, a remaining capacity together with the control part 310.

In a temperature detection part 318, the temperature is measured using the temperature detection device 308, thereby carrying out the charge and discharge control at the time of abnormal heat generation or carrying out the correction in calculating the remaining capacity.

### 5. Fifth Embodiment

The foregoing nonaqueous electrolyte battery and battery pack using the same can be mounted in appliances, for example, an electronic appliance, an electric vehicle, an electricity storage apparatus, etc. or used for the purpose of supplying an electric power to these appliances.

Examples of the electronic appliance include a laptop personal computer, PDA (personal digital assistants), a mobile phone, a cordless phone handset, a video movie camera, a digital still camera, an electronic book, an electronic dictionary, a music player, a radio, a headphone, a game player, a navigation system, a memory card, a pacemaker, a hearing aid, a power tool, an electric shaver, a refrigerator, an air conditioner, a television receiver, a stereo, a water heater, a microwave oven, a dishwasher, a washing machine, a dryer, an illuminator, a toy, a medical appliance, a robot, a road conditioner, and a signal.

Also, examples of the electric vehicle include a railway vehicle, a golf cart, an electric cart, and an electric car (inclusive of a hybrid car), and the foregoing nonaqueous electrolyte battery and battery pack using the same are used as a driving power source or auxiliary power source for these electric vehicles.

Examples of the electricity storage apparatus include a power source for electricity storage used for buildings including houses or electric power generation facilities.

Among the foregoing application examples, specific examples of the electricity storage system using an electricity storage apparatus to which the foregoing nonaqueous electrolyte battery of the embodiment of the present disclosure is applied are hereunder described.

Examples of this electricity storage system include the following configurations. A first electricity storage system is an electricity storage system in which the electricity storage apparatus is charged by an electric power generation apparatus for performing the electric power generation from renewable energy. A second electricity storage system is an electricity storage system having an electricity storage apparatus and supplying an electric power to an electronic appliance to be connected to the electricity storage apparatus. A third electricity storage system is an electric appliance which receives the supply of an electric power from an electricity storage apparatus. These electricity storage systems are carried out as a system for contriving to efficiently supply an electric power in cooperation with an external electric power supply network.

Furthermore, a fourth electricity storage system is an electric vehicle having a conversion apparatus of receiving the supply of an electric power from an electricity storage apparatus and converting it to a driving force of the vehicle and a control apparatus of performing information processing regarding the vehicle control on the basis of the information regarding the electricity storage apparatus. A fifth electricity storage system is an electric power system including an electric power information transmission and reception part for transmitting and receiving signals relative to other appliance via a network and performing charge and discharge control of the foregoing electricity storage apparatus on the basis of the information which the transmission and reception part receives. A sixth electricity storage system is an electric power system of receiving the supply of an electric power from the foregoing electricity storage apparatus, or supplying an electric power to the electricity storage apparatus from the electric power generation apparatus or electric power network. The electricity storage systems are hereunder described.

### (5-1) Electricity Storage System in House as Application Example:

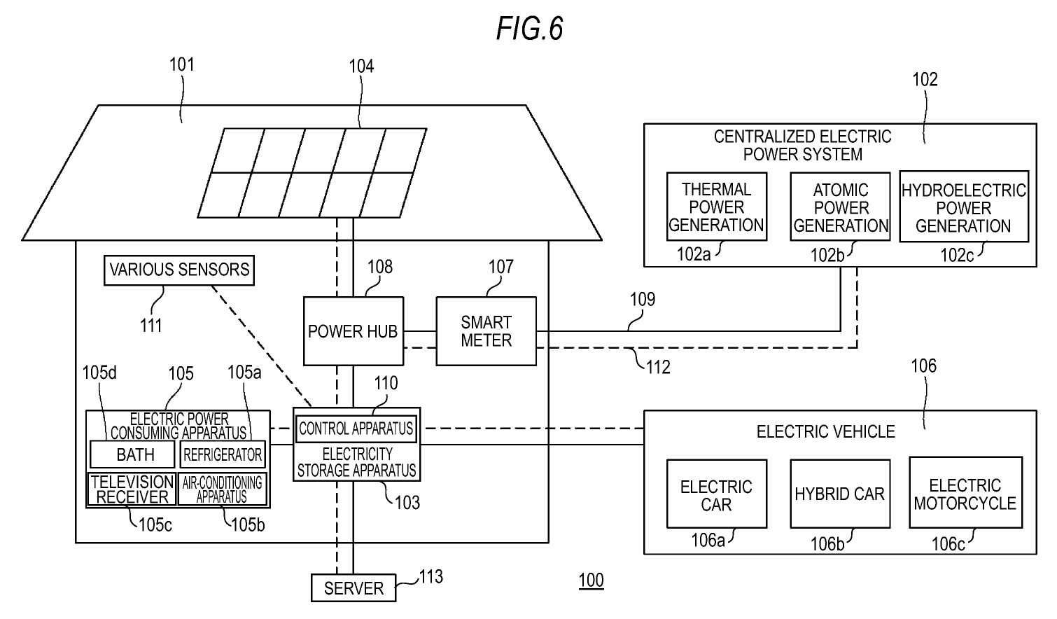

An example in which the electricity storage apparatus using the nonaqueous electrolyte battery of the embodiment of the present disclosure is applied to an electricity storage system for house is described by reference to FIG. 6. For example, in an electricity storage system 100 for a house 101, an electric power is supplied to an electricity storage apparatus 103 from a centralized electric power system 102 including thermal power generation 102a, atomic power generation 102b, hydroelectric power generation 102c, and the like via an electric power network 109, an information network 112, a smart meter 107, a power hub 108, and the like. At the same time, an electric power is supplied to the electricity storage apparatus 103 from an independent power source such as a domestic electric power generation apparatus 104. The electric power supplied to the electricity storage apparatus 103 is stored. An electric power to be used in the house 101 is supplied using the electricity storage apparatus 103. The same electricity storage system can be used for not only the house 101 but buildings.

The house 101 is provided with the electric power generation apparatus 104, an electric power consuming apparatus 105, the electricity storage apparatus 103, a control apparatus 110 for controlling various apparatuses, the smart meter 107, and various sensors 111 for acquiring information. The respective apparatuses are connected to each other by the electric power network 109 and the information network 112. As the electric power generation apparatus 104, a solar cell, a fuel cell, and the like are utilized, and the generated electric power is supplied to the electric power consuming apparatus 105 and/or the electricity storage apparatus 103. The electric power consuming apparatus 105 includes a refrigerator 105a, an air-conditioning apparatus 105b, a television receiver 105c, a bath 105d, and so on. Furthermore, the electric power consuming apparatus 105 includes an electric vehicle 106. The electric vehicle 106 includes an electric car 106a, a hybrid car 106b, and an electric motorcycle 106c.

The nonaqueous electrolyte battery of the embodiment of the present disclosure is applied to the electricity storage apparatus 103. The nonaqueous electrolyte battery of the embodiment of the present disclosure may be, for example, constituted of the foregoing lithium ion secondary battery. The smart meter 107 is provided with a function to measure the use amount of a commercial electric power and transmit the measured use amount to an electric power company. The electric power network 109 may be combined with any one or a plurality of direct current electricity supply, alternating current electricity supply, and non-contact electricity supply.

Examples of the various sensors 111 include a human sensitive sensor, an illuminance sensor, an object detection sensor, a consumed electric power sensor, a vibration sensor, a contact sensor, a temperature sensor, and an infrared ray sensor. The information acquired by the various sensors 111 is transmitted to the control apparatus 110. According to the information from the sensors 111, the state of weather, the state of a human, or the like is grasped, and the electric power consuming apparatus 105 is automatically controlled, thereby enabling one to minimize the energy consumption. Furthermore, the control apparatus 110 is able to transmit the information regarding the house 101 to an external electric power company or the like via internet.

Processing such as branching of an electric power line and direct current-alternating current conversion is performed by the power hub 108. Examples of a communication system of the information network 112 which is connected to the control apparatus 110 include a method of using a communication interface such as UART (universal asynchronous receive-transceiver) and a method of utilizing a sensor network according to the radio communication standards such as Bluetooth, ZigBee, and Wi-Fi. The Bluetooth system is applied to the multimedia communication, thereby enabling one to achieve communication of one-to-many connections. The ZigBee uses the physical layer of IEEE (Institute of Electrical and Electronics Engineers) 802.15.4. IEEE 802.15.4 is a name of the wireless personal area network standards called PAN (personal area network) or WPAN (wireless personal area network).

The control apparatus 110 is connected to an external server 113. This server 113 may be controlled by any one of the house 101, an electric power company and a service provider. Examples of the information which the server 113 transmits and receives include consumed electric power information, life pattern information, electric power charge, weather information, natural disaster information, and electric power trade. Though a domestic electric power consuming apparatus (for example, a television receiver) may transmit and receive such information, an apparatus outside the home (for example, a mobile phone, etc.) may also transmit and receive the information. Such information may be displayed on an appliance having a display function, for example, a television receiver, a mobile phone, PDA (personal digital assistants), etc.

The control apparatus 110 for controlling the respective parts is constituted of CPU (central processing unit), RAM (random access memory), ROM (read only memory), and so on, and in this example, the control apparatus 110 is housed in the electricity storage apparatus 103. The control apparatus 110 is connected to the electricity storage apparatus 103, the domestic electric power generation apparatus 104, the electric power consuming apparatus 105, the various sensors 111, and the server 113 by the information network 112, and for example, it has a function to adjust the use amount of a commercial electric power and the amount of electric power generation. Incidentally, besides, the control apparatus 110 may include a function to perform electric power trade in the electric power market.

In the light of the above, the generated electric power of not only the centralized electric power system 102 whose electric power comes from the thermal power generation 102a, the atomic power generation 10b, the hydroelectric power generation 102c, and the like but the domestic electric power generation apparatus 104 (by photovoltaic power generation and wind power generation) can be stored in the electricity storage apparatus 103. In consequence, even when the generated electric power of the domestic electric power generation apparatus 104 changes, it is possible to perform the control such that the amount of electric power to be sent out externally is made constant, or only a necessary amount of discharge is achieved. For example, there may also be adopted a manner of use such that not only an electric power obtained by photovoltaic power generation is stored in the electricity storage apparatus 103, but a late-night electric power whose charge is inexpensive in the night is stored in the electricity storage apparatus 103, and the electric power stored by the electricity storage apparatus 103 is discharged and utilized in a time zone of the daytime where the charge is expensive.

Incidentally, in this example, while an example in which the control apparatus 110 is housed within the electricity storage apparatus 103 has been described, the control apparatus 110 may be housed within the smart meter 107, or may be constituted alone. Furthermore, the electricity storage system 100 may be used while making a plurality of homes in an apartment house objective, or making a plurality of independent houses objective.

### (5-2) Electricity Storage System in Vehicle as Application Example:

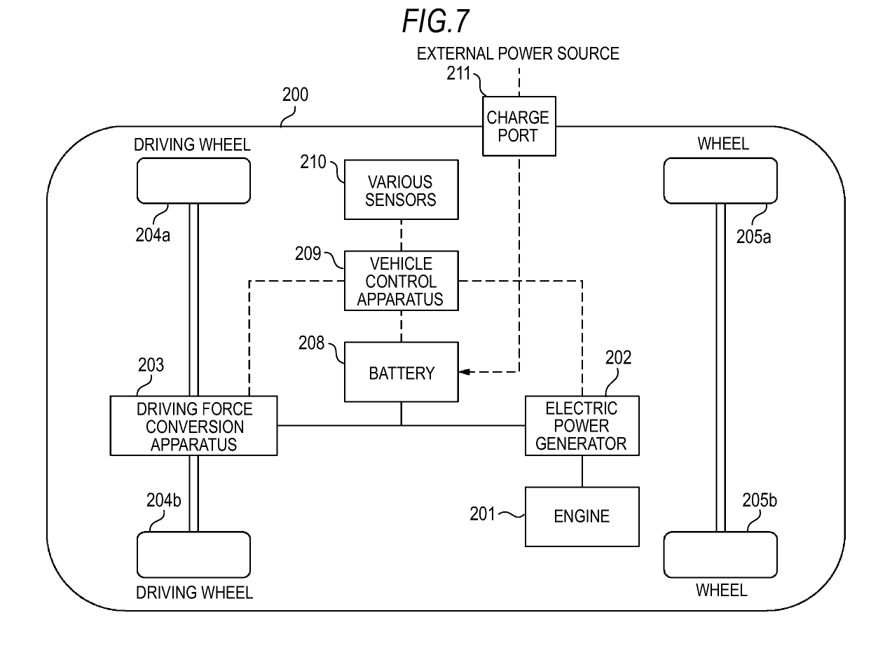

An example in which the present disclosure is applied to an electricity storage system for vehicle is described by reference to FIG. 7. FIG. 7 diagrammatically shows an example of a configuration of a hybrid vehicle adopting a series hybrid system to which the present disclosure is applied. The series hybrid system is a vehicle running with an electric power driving force conversion apparatus using an electric power generated by an electric power generator to be operated by an engine, or an electric power obtained by once storing the foregoing electric power in a battery.

This hybrid vehicle 200 is mounted with an engine 201, an electric power generator 202, an electric power driving force conversion apparatus 203, a driving wheel 204a, a driving wheel 204b, a wheel 205a, a wheel 205b, a battery 208, a vehicle control apparatus 209, various sensors 210, and a charge port 211. The foregoing nonaqueous electrolyte battery of the embodiment of the present disclosure is applied to the battery 208.

The hybrid vehicle 200 runs using the electric power driving force conversion apparatus 203 as a power source. An example of the electric power driving force conversion apparatus 203 is a motor. The electric power driving force conversion apparatus 203 is actuated by the electric power of the battery 208, and a torque of this electric power driving force conversion apparatus 203 is transmitted to the driving wheels 204a and 204b. Incidentally, any of an alternating current motor or a direct current motor is applicable to the electric power driving force conversion apparatus 203 by using direct current-alternating current (DC-AC) conversion or reverse conversion (AC-DC conversion) in a necessary area. The various sensors 210 control the engine speed via the vehicle control apparatus 209, or control an opening of a non-illustrated throttle valve (throttle opening). The various sensors 210 include a speed sensor, an acceleration sensor, and an engine speed sensor.

A torque of the engine 201 is transmitted to the electric power generator 202, and an electric power produced in the electric power generator 202 by that torque can be stored in the battery 208.

When the hybrid vehicle 200 slows down due to a non-illustrated braking mechanism, the resistance at the time of slowdown is added as a torque to the electric power driving force conversion apparatus 203, and a regenerative electric power produced by the electric power driving force conversion apparatus 203 due to that torque is stored in the battery 208.

When the battery 208 is connected to an external power source of the hybrid vehicle 200, it receives the supply of an electric power from the external power source through the charge port 211 as an input port, and it is also possible to store the received electric power.

While illustration is omitted, an information processing apparatus for performing the information processing regarding vehicle control on the basis of the information regarding a secondary battery may be included. Examples of such an information processing apparatus include an information processing apparatus for performing display of a remaining battery life on the basis of the information regarding the remaining battery life.

Incidentally, as described above, the series hybrid vehicle running with a motor using an electric power generated by an electric power generator to be operated by an engine, or an electric power obtained by once storing the foregoing electric power in a battery has been described as an example. However, it is possible to effectively apply the present disclosure to a parallel hybrid vehicle using outputs of all of an engine and a motor as driving sources, which is used by properly switching three systems including running with only the engine, running with only the motor, and running with both of the engine and the motor. Furthermore, it is possible to effectively apply the present disclosure to a so-called electric vehicle running by driving with only a drive motor without using an engine.

### EXAMPLES

The present disclosure is hereunder specifically described with reference to the following Examples and Comparative Examples, but it should not be construed that the present disclosure is limited thereto. Incidentally, in the following respective Examples, additives of the present disclosure shown by the following Compounds 1 to 7 and Compound 15 were used. Also, in the following respective Comparative Examples, existing additives shown by the following Compounds 8 to 14 were used.

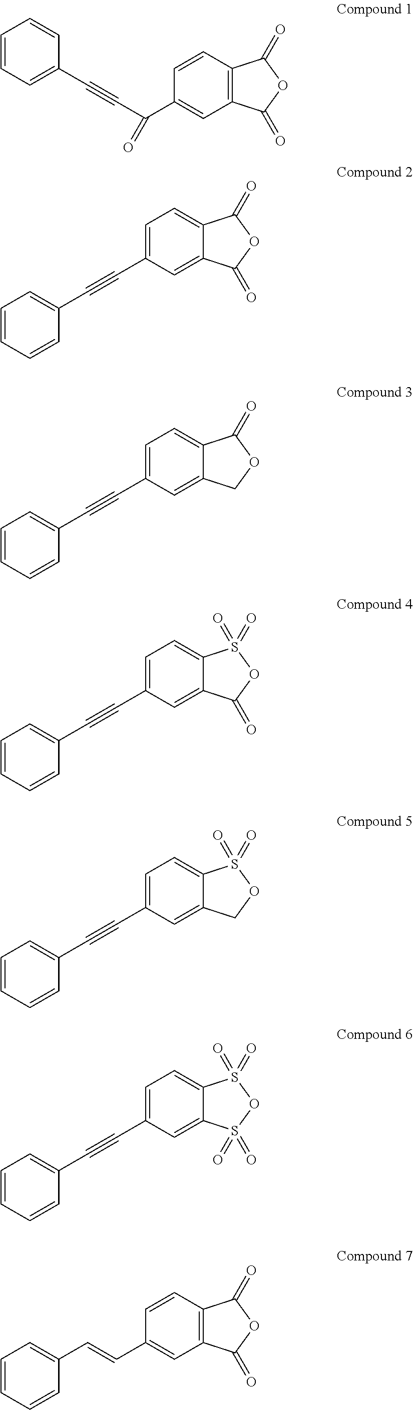

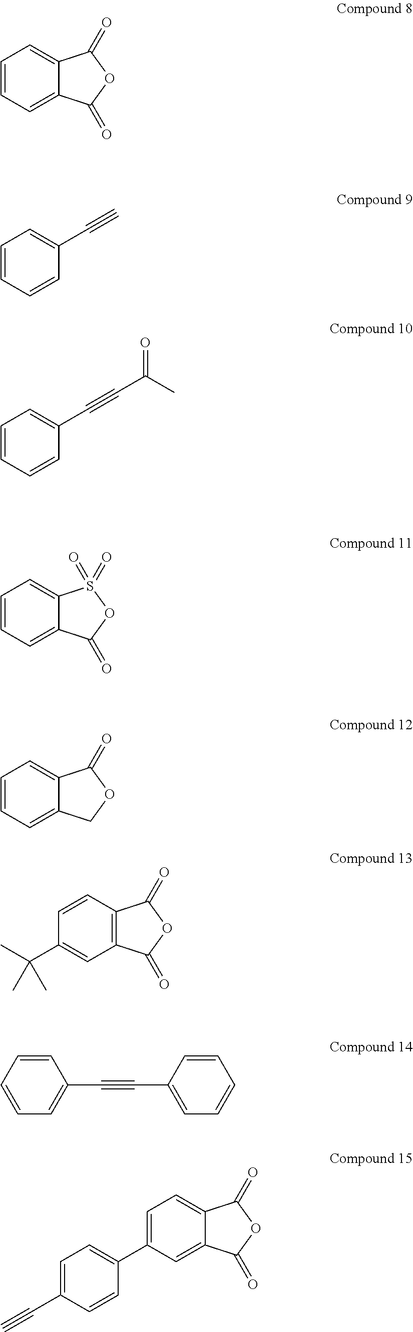

### Example 1

### Fabrication of Positive Electrode

Lithium carbonate (Li₂CO₃) and cobalt carbonate (CoCO₃) were mixed in a molar ratio of 0.5/1 and then baked in air at 900° C. for 5 hours to obtain a lithium cobalt complex oxide (LiCoO₂). Subsequently, 91 parts by mass of the foregoing lithium cobalt complex oxide (LiCoO₂) as a positive electrode active material, 6 parts by mass of graphite as a conductive agent, and 3 parts by mass of polyvinylidene fluoride as a binder were mixed to prepare a positive electrode mixture. Subsequently, the positive electrode mixture was dispersed in N-methyl-2-pyrrolidone to prepare a positive electrode mixture slurry in a paste form.

Thereafter, the positive electrode mixture slurry was coated on the both surfaces of a positive electrode collector made of a strip-shaped aluminum foil (12 μm in thickness), and after drying, the resultant was compression molded by a roll press to form a positive electrode active material layer. Finally, an aluminum-made positive electrode lead was installed in one end of the positive electrode collector by means of welding.

### [Fabrication of Negative Electrode]

97 parts by mass of an artificial graphite powder as a negative electrode active material and 3 parts by mass of polyvinylidene fluoride as a binder were mixed to prepare a negative electrode mixture. Subsequently, the negative electrode mixture was dispersed in N-methyl-2-pyrrolidone to prepare a negative electrode mixture slurry in a paste form.

Thereafter, the negative electrode mixture slurry was coated on the both surfaces of a negative electrode collector made of a strip-shaped copper foil (15 μm in thickness), and after drying, the resultant was compression molded by a roll press to form a negative electrode active material layer. Finally, a nickel-made negative electrode lead was installed in one end of the negative electrode collector by means of welding.

### [Assembling of Battery]

The thus fabricated positive electrode and negative electrode were used, and the positive electrode, a separator made of a microporous polypropylene film (25 μm in thickness), the negative electrode, and the foregoing separator were laminated in this order to form a laminated electrode body. Subsequently, the laminated electrode body was spirally wound many times, and an end of winding was fixed by an adhesive tape to form a wound electrode body.

Subsequently, a nickel-plated iron-made battery can was prepared; the wound electrode body was interposed between a pair of insulating plates; and the negative electrode lead was welded to the battery can, and also, the positive electrode lead was welded to a safety valve mechanism electrically connected to a battery lid. Subsequently, the wound electrode body was housed in the inside of the battery can, and an electrolytic solution was injected into the inside of the battery can in a pressure reduction mode.

Incidentally, the electrolytic solution was prepared in the following manner. That is, ethylene carbonate (EC) and dimethyl carbonate (DMC) as nonaqueous solvents, and lithium hexafluorophosphate (LiPF₆) as an electrolyte salt were mixed in a proportion of ethylene carbonate (EC)/dimethyl carbonate (DMC)/lithium hexafluorophosphate (LiPF₆) of 20/65/15 in terms of a mass ratio. Furthermore, Compound 1 was added in an amount of 0.005% by mass relative to the whole mass of the electrolytic solution.

Subsequently, the battery lid was caulked with the battery can via a gasket having asphalt coated on the surface thereof, thereby fixing the safety valve mechanism 15, the positive temperature coefficient device 16 and the battery lid 14. There was thus completed a secondary battery of a cylinder type in which the air tightness in the inside of the battery can was ensured.

### Example 2

A secondary battery was fabricated in the same manner as that in Example 1, except that in preparing the electrolytic solution, the addition amount of Compound 1 was set to 0.01% by mass.

### Example 3

A secondary battery was fabricated in the same manner as that in Example 1, except that in preparing the electrolytic solution, the addition amount of Compound 1 was set to 0.10% by mass.

### Example 4

A secondary battery was fabricated in the same manner as that in Example 1, except that in preparing the electrolytic solution, the addition amount of Compound 1 was set to 0.50% by mass.

### Example 5

A secondary battery was fabricated in the same manner as that in Example 1, except that in preparing the electrolytic solution, the addition amount of Compound 1 was set to 1.0% by mass.

### Example 6

A secondary battery was fabricated in the same manner as that in Example 1, except that in preparing the electrolytic solution, the addition amount of Compound 1 was set to 5.0% by mass.

### Example 6

A secondary battery was fabricated in the same manner as that in Example 1, except that in preparing the electrolytic solution, the addition amount of Compound 1 was set to 10% by mass.

### Examples 8 to 14

Secondary batteries were fabricated in the same manners as those in Examples 1 to 7, respectively, except that in preparing the electrolytic solution, Compound 2 was added in place of the Compound 1.

### Examples 15 to 21

Secondary batteries were fabricated in the same manners as those in Examples 1 to 7, respectively, except that in preparing the electrolytic solution, Compound 3 was added in place of the Compound 1.

### Examples 22 to 28

Secondary batteries were fabricated in the same manners as those in Examples 1 to 7, respectively, except that in preparing the electrolytic solution, Compound 4 was added in place of the Compound 1.

### Examples 29 to 35

Secondary batteries were fabricated in the same manners as those in Examples 1 to 7, respectively, except that in preparing the electrolytic solution, Compound 5 was added in place of the Compound 1.

### Examples 36 to 42

Secondary batteries were fabricated in the same manners as those in Examples 1 to 7, respectively, except that in preparing the electrolytic solution, Compound 6 was added in place of the Compound 1.

### Examples 43 to 49

Secondary batteries were fabricated in the same manners as those in Examples 1 to 7, respectively, except that in preparing the electrolytic solution, Compound 7 was added in place of the Compound 1.

### Example 50

A secondary battery was fabricated in the same manner as that in Example 5, except that in preparing the electrolytic solution, Compound 15 (4-ethynylphenyl-2-sulfobenzoic acid) was added in place of the Compound 1.

### Comparative Example 1

A secondary battery was fabricated in the same manner as that in Example 1, except that in preparing the electrolytic solution, Compound 1 was not added.

### Comparative Example 2

A secondary battery was fabricated in the same manner as that in Example 5, except that in preparing the electrolytic solution, Compound 8 (phthalic anhydride) was added in place of the Compound 1.

### Comparative Example 3

A secondary battery was fabricated in the same manner as that in Example 5, except that in preparing the electrolytic solution, Compound 9 (phenylacetylene) was added in place of the Compound 1.

### Comparative Example 4

A secondary battery was fabricated in the same manner as that in Example 1, except that in preparing the electrolytic solution, Compound 8 (phthalic anhydride) and Compound 9 (phenylacetylene) were added in an addition amount of each compound of 0.50% by mass relative to the whole mass of the electrolytic solution, in place of the Compound 1.

### Comparative Example 5

A secondary battery was fabricated in the same manner as that in Example 5, except that in preparing the electrolytic solution, Compound 10 (4-phenyl-3-Butyn-2-one) was added in place of the Compound 1.

### Comparative Example 6

A secondary battery was fabricated in the same manner as that in Example 1, except that in preparing the electrolytic solution, Compound 8 (phthalic anhydride) and Compound 10 (4-phenyl-3-butyn-2-one) were added in an addition amount of each compound of 0.50% by mass relative to the whole mass of the electrolytic solution, in place of the Compound 1.

### Comparative Example 7

A secondary battery was fabricated in the same manner as that in Example 5, except that in preparing the electrolytic solution, Compound 11 (2-sulfobenzoic acid) was added in place of the Compound 1.

### Comparative Example 8

A secondary battery was fabricated in the same manner as that in Example 1, except that in preparing the electrolytic solution, Compound 11 (2-sulfobenzoic acid) and Compound 9 (phenylacetylene) were added in an addition amount of each compound of 0.50% by mass relative to the whole mass of the electrolytic solution, in place of the Compound 1.

### Comparative Example 9

A secondary battery was fabricated in the same manner as that in Example 5, except that in preparing the electrolytic solution, Compound 12 (phthalide) was added in place of the Compound 1.

### Comparative Example 10

A secondary battery was fabricated in the same manner as that in Example 1, except that in preparing the electrolytic solution, Compound 12 (phthalide) and Compound 9 (phenylacetylene) were added in an addition amount of each compound of 0.50% by mass relative to the whole mass of the electrolytic solution, in place of the Compound 1.

### Comparative Example 11

A secondary battery was fabricated in the same manner as that in Example 5, except that in preparing the electrolytic solution, Compound 13 (4-tert-butylphthalic anhydride) was added in place of the Compound 1.

### Comparative Example 12

A secondary battery was fabricated in the same manner as that in Example 5, except that in preparing the electrolytic solution, Compound 14 (diphenylacetylene) was added in place of the Compound 1.

### [Evaluation]

With respect to the secondary batteries of Examples 1 to 50 and Comparative Examples 1 to 12, the following high-temperature storage test was carried out.

### (High-Temperature Storage Test)

With respect to the secondary batteries of the foregoing respective Examples and Comparative Examples, two cycles of charge and discharge were carried out under an atmosphere at 23° C.; and charge at the third cycle was further carried out in an atmosphere at 23° C., followed by storage under an atmosphere at 60° C. for 2 weeks. After the storage under a high-temperature environment, the secondary batteries of the respective Examples and Comparative Examples were returned to the atmosphere at 23° C. and discharged.

Here, the capacity retention rate was defined as follows.

Capacity retention rate [%]={(Discharge capacity at the third cycle)/(Discharge capacity at the second cycle)}×100

Also, after completion of the storage, charge was carried out, thereby evaluating the subsequent discharge capacity.

Capacity recovery rate [%]={(Discharge capacity at the fourth cycle)/(Discharge capacity at the second cycle)}×100

Incidentally, as to a charge condition of one cycle, the battery was charged at a constant current of 1 mA/cm² until the battery voltage reached 4.2 V; and the battery was further charged at a constant voltage of 4.2 V until the current reached 0.02 mA/cm². Also, as to the discharge condition of one cycle, the battery was discharged at a constant current of 1 mA/cm² until the battery voltage reached 3.0 V.

The evaluation results are shown in Table 1.

TABLE 1

| | Additive | | | |
|---|---|---|---|---|
| | | Addition | Capacity | Capacity |
| | | amount | retention rate | recovery rate |
| | Kind | [% by mass] | [%] | [%] |
| Example 1 | Compound 1 | 0.005 | 53.5 | 67.3 |
| Example 2 | | 0.01 | 80.3 | 87.4 |
| Example 3 | | 0.10 | 91.2 | 92.8 |
| Example 4 | | 0.50 | 92.9 | 94.1 |
| Example 5 | | 1.0 | 93.6 | 94.2 |
| Example 6 | | 5.0 | 69.4 | 82.4 |
| Example 7 | | 10 | 51.2 | 59.3 |
| Example 8 | Compound 2 | 0.005 | 52.4 | 69.5 |
| Example 9 | | 0.01 | 78.4 | 86.5 |
| Example 10 | | 0.10 | 92.4 | 93.1 |
| Example 11 | | 0.50 | 92.4 | 93.4 |
| Example 12 | | 1.0 | 92.7 | 93.1 |
| Example 13 | | 5.0 | 70.1 | 85.5 |
| Example 14 | | 10 | 48.6 | 58.9 |
| Example 15 | Compound 3 | 0.005 | 49.1 | 66.0 |
| Example 16 | | 0.01 | 75.8 | 85.3 |
| Example 17 | | 0.10 | 89.5 | 90.6 |
| Example 18 | | 0.50 | 90.6 | 91.0 |
| Example 19 | | 1.0 | 90.7 | 91.1 |
| Example 20 | | 5.0 | 68.9 | 80.6 |
| Example 21 | | 10 | 49.7 | 57.4 |
| Example 22 | Compound 4 | 0.005 | 51.0 | 67.6 |
| Example 23 | | 0.01 | 77.4 | 85.5 |
| Example 24 | | 0.10 | 90.6 | 91.9 |
| Example 25 | | 0.50 | 91.1 | 92.2 |
| Example 26 | | 1.0 | 91.0 | 92.6 |
| Example 27 | | 5.0 | 68.3 | 81.3 |
| Example 28 | | 10 | 51.5 | 59.8 |
| Example 29 | Compound 5 | 0.005 | 54.1 | 66.8 |
| Example 30 | | 0.01 | 78.6 | 86.7 |
| Example 31 | | 0.10 | 91.1 | 93.0 |
| Example 32 | | 0.50 | 91.0 | 92.6 |
| Example 33 | | 1.0 | 91.3 | 92.7 |
| Example 34 | | 5.0 | 67.3 | 80.3 |
| Example 35 | | 10 | 52.0 | 61.3 |
| Example 36 | Compound 6 | 0.005 | 53.4 | 66.5 |
| Example 37 | | 0.01 | 76.5 | 86.4 |
| Example 38 | | 0.10 | 92.6 | 93.5 |
| Example 39 | | 0.50 | 94.1 | 94.6 |
| Example 40 | | 1.0 | 93.9 | 94.6 |
| Example 41 | | 5.0 | 64.2 | 81.2 |
| Example 42 | | 10 | 47.8 | 60.9 |
| Example 43 | Compound 7 | 0.005 | 51.3 | 64.3 |
| Example 44 | | 0.01 | 74.3 | 84.6 |
| Example 45 | | 0.10 | 87.4 | 90.3 |
| Example 46 | | 0.50 | 88.3 | 91.0 |
| Example 47 | | 1.0 | 86.9 | 90.5 |
| Example 48 | | 5.0 | 64.3 | 81.3 |
| Example 49 | | 10 | 53.0 | 61.6 |
| Example 50 | Compound 15 | 1.0 | 55.4 | 69.6 |
| Comparative | — | — | 46.0 | 54.3 |
| Example 1 | | | | |
| Comparative | Compound 8 | 1.0 | 57.3 | 76.2 |
| Example 2 | | | | |
| Comparative | Compound 9 | 1.0 | 53.1 | 73.5 |
| Example 3 | | | | |
| Comparative | Compound 8 | 0.5 | 64.1 | 79.4 |
| Example 4 | Compound 9 | 0.5 | | |
| Comparative | Compound 10 | 1.0 | 52.4 | 75.1 |
| Example 5 | | | | |
| Comparative | Compound 8 | 0.5 | 63.1 | 78.9 |
| Example 6 | Compound 10 | 0.5 | | |
| Comparative | Compound 11 | 1.0 | 59.8 | 78.4 |
| Example 7 | | | | |
| Comparative | Compound 11 | 0.5 | 62.5 | 80.1 |
| Example 8 | Compound 9 | 0.5 | | |
| Comparative | Compound 12 | 1.0 | 56.4 | 74.6 |
| Example 9 | | | | |
| Comparative | Compound 12 | 0.5 | 63.2 | 76.1 |
| Example 10 | Compound 9 | 0.5 | | |
| Comparative | Compound 13 | 1.0 | 54.3 | 72.1 |
| Example 11 | | | | |
| Comparative | Compound 14 | 1.0 | 52.7 | 71.6 |
| Example 12 | | | | |

As shown in Table 1, it can be confirmed that the high-temperature storage characteristic was improved by adding the compound represented by the general formula (I), such as Compounds 1 to 7 and 15, to the electrolytic solution. On the other hand, in the case of not adding the compound represented by the general formula (I), such as Compounds 1 to 7 and 15, to the electrolytic solution, the high-temperature storage characteristic was not improved as compared with the case of adding the compound represented by the general formula (I).

Also, even by adding a compound having respective constituent elements analogous to those of the compound represented by the general formula (I) to the electrolytic solution, the high-temperature storage characteristic was not improved as compared with the case of adding the compound represented by the general formula (I). That is, in comparison with the case of adding the parent compound of the general formula (I) alone as in Comparative Examples 2, 7 and 9, in the case of adding the compound represented by the general formula (I) corresponding thereto, the high-temperature storage characteristic was improved. In comparison with the case of adding a compound analogous to the substituent R of the general formula (I) alone as in Comparative Examples 3 and 5, in the case of adding the compound represented by the general formula (I) corresponding thereto, the high-temperature storage characteristic was improved. In comparison with the case of adding both of the parent compound of the general formula (I) and a compound analogous to the substituent R as in Comparative Examples 4, 6, 8 and 10, in the case of adding the parent compound of the general formula (I) corresponding thereto, the high-temperature storage characteristic was improved. In comparison with the case of adding a compound analogous to the compound of the general formula (I) as in Comparative Examples 11, 12 and 13, in the case of adding the parent compound of the general formula (I) corresponding thereto, the high-temperature storage characteristic was improved. It may be said from the foregoing that the effect for improving the high-temperature storage characteristic is an effect which is specifically found in the compound represented by the general formula (I) in which the respective constituent elements (namely, the substituent R and the parent compound of the general formula (I)) are coupled with each other.

Also, as shown in Table 1, it could be confirmed that the addition amount of the compound represented by the general formula (I) is preferably 0.01% by mass or more and not more than 5.0% by mass, and more preferably 0.01% by mass or more and not more than 1.0% by mass.

Also, as is noted from the comparison between Example 26 and Example 50, in comparison with the case where the end of the substituent R is an unsaturated bond, a more preferred effect was obtained in the case where the end of the substituent R is an aromatic ring. It may be considered that this was caused due to the fact that in the case where an unsaturated bond is present at the end of the substituent R, decomposition of the unsaturated bond preferentially occurs, so that the effect obtained by the matter that the substituent R and the parent compound of the general formula (I) are bound to each other is reduced.

### 6. Other Embodiments

It should not be construed that the present disclosure is limited to the foregoing embodiments according to the present disclosure, and various modifications and applications can be made therein so far as the gist of the present disclosure is not deviated. For example, in the foregoing first to third embodiments, while the secondary batteries of a cylindrical type or a flat type (laminate type) have been exemplified, the present disclosure can be similarly applied to secondary batteries of a button type, a thin type, a large-sized type, or a stacked laminate type.

Also, in the foregoing embodiments and working examples, the nonaqueous electrolyte battery having a wound structure has been described by reference to specific examples thereof, but it should not be construed that the present disclosure is limited thereto. For example, the present disclosure can be similarly applied to the case provided with a battery element in which one or plural positive electrodes and negative electrodes are stacked and formed in a zigzag pattern, or nonaqueous electrolyte batteries having other stack structure in which one or plural positive electrodes and negative electrodes are stacked.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A nonaqueous electrolyte battery comprising:
a positive electrode,
a negative electrode, and
a nonaqueous electrolyte containing a nonaqueous electrolytic solution,
wherein
the nonaqueous electrolytic solution contains a compound represented by the following general formula (I) 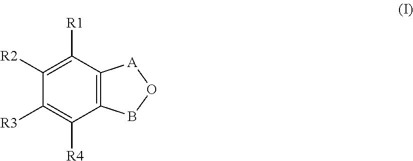
wherein, in the general formula (I), each of R1 to R4 independently represents a group having a hydrocarbon group having at least one aromatic ring and at least one unsaturated bond or a hydrogen atom, provided that at least one of R1 to R4 is a group having a hydrocarbon group having at least one aromatic ring and at least one unsaturated bond; and each of A and B independently represents a carbonyl group, a sulfonyl group, or a methylene group, provided that at least one of A and B is a carbonyl group or a sulfonyl group.

2. The nonaqueous electrolyte battery according to claim 1, wherein the compound represented by the general formula (I) is a compound represented by any one of the following general formulae (I-1) to (I-5) 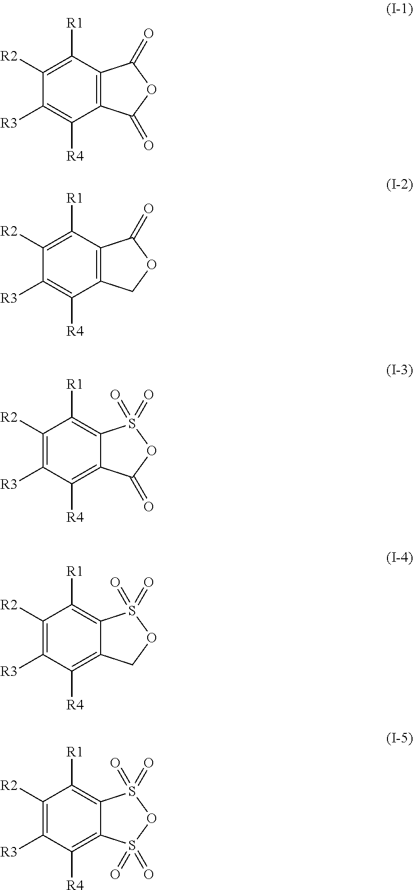
wherein, in the general formulae (I-1) to (I-5), each of R1 to R4 independently represents a group having a hydrocarbon group having at least one aromatic ring and at least one unsaturated bond or a hydrogen atom, provided that at least one of R1 to R4 is a group having a hydrocarbon group having at least one aromatic ring and at least one unsaturated bond.

3. The nonaqueous electrolyte battery according to claim 1, wherein in the general formula (I), the group having a hydrocarbon group having at least one aromatic ring and at least one unsaturated bond is a group having a hydrocarbon group having at least one aromatic ring and at least one unsaturated bond located at a position other than an end thereof.

4. The nonaqueous electrolyte battery according to claim 1, wherein the group having a hydrocarbon group having at least one aromatic ring and at least one unsaturated bond is a group represented by the following general formula (II) or (III) 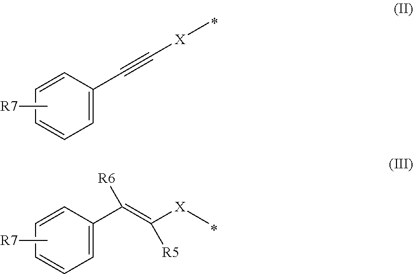
wherein each of R5 and R6 in the general formula (II), independently represents a hydrogen atom or a hydrocarbon group; R7 in the general formulae (II) and (III) represents a substituent bound to the aromatic ring; X in the general formula (III) represents a connecting group between the unsaturated bond bound to the aromatic ring and the parent compound; and the * mark in the general formulae (II) and (III) expresses a point connecting to the parent compound of the general formula (I).

5. The nonaqueous electrolyte battery according to claim 1, wherein a content of the compound represented by the general formula (I) is 0.01% by mass or more and not more than 5.0% by mass relative to the whole mass of the nonaqueous electrolytic solution.

6. The nonaqueous electrolyte battery according to claim 4, wherein the group represented by the general formula (II) is any one of a group of substituents of the following Substituents A to O

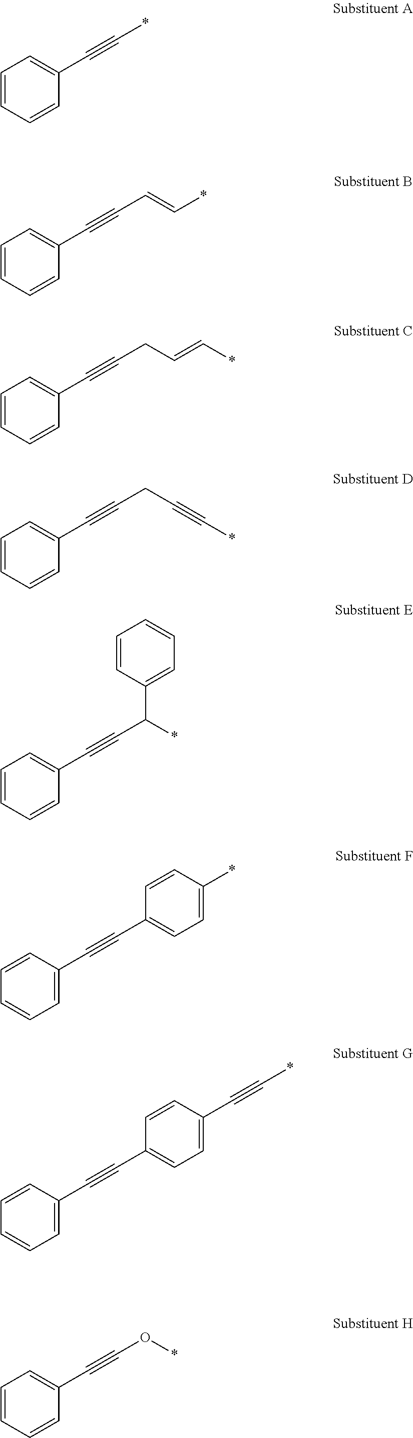

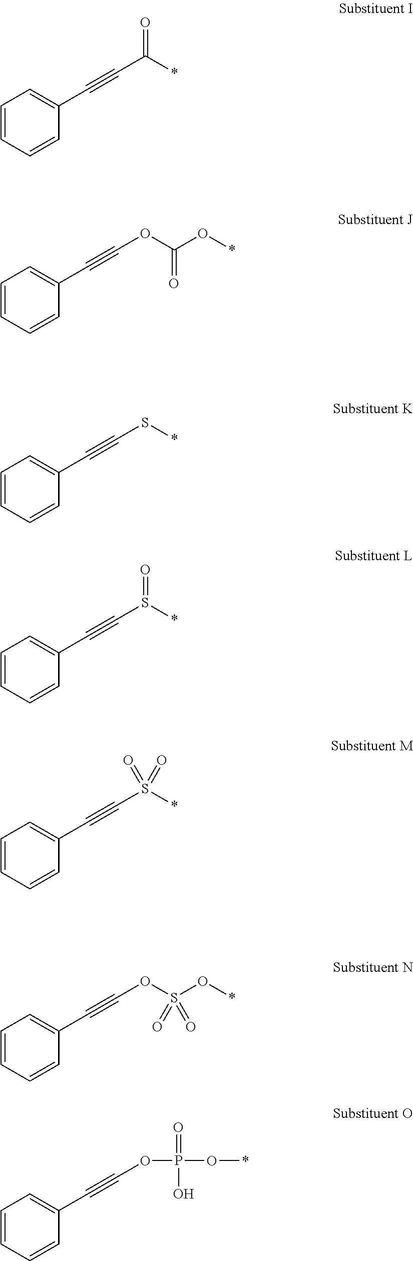

7. The nonaqueous electrolyte battery according to claim 4, wherein the group represented by the general formula (III) is any one of a group of substituents of the following Substituents A′ to O′

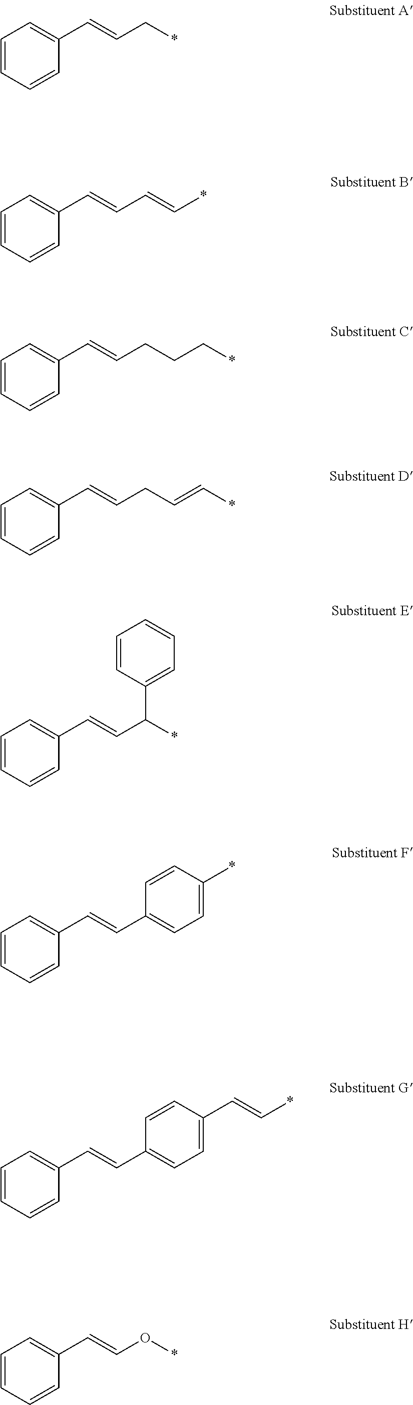

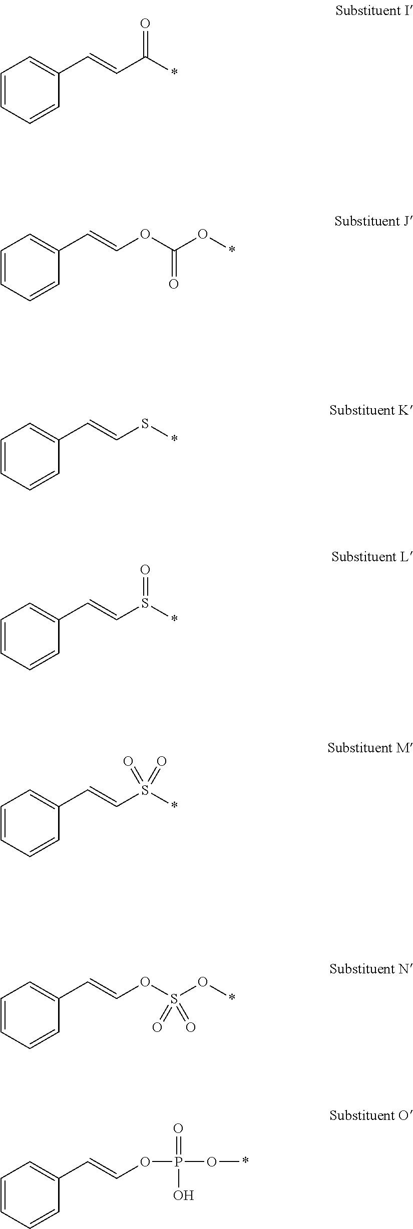

8. The nonaqueous electrolyte battery according to claim 1, wherein the nonaqueous electrolytic solution further contains at least one of an unsaturated carbonate and a halogenated carbonate.

9. The nonaqueous electrolyte battery according to claim 1, wherein the nonaqueous electrolyte further contains a polymer compound for holding the nonaqueous electrolytic solution therein.

10. A nonaqueous electrolyte comprising:
a nonaqueous electrolytic solution containing a compound represented by the following general formula (I) 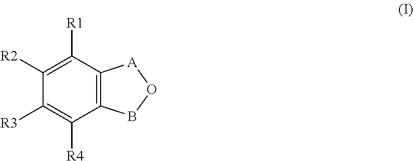
wherein, in the general formula (I), each of R1 to R4 independently represents a group having a hydrocarbon group having at least one aromatic ring and at least one unsaturated bond or a hydrogen atom, provided that at least one of R1 to R4 is a group having a hydrocarbon group having at least one aromatic ring and at least one unsaturated bond; and each of A and B independently represents a carbonyl group, a sulfonyl group, or a methylene group, provided that at least one of A and B is a carbonyl group or a sulfonyl group.

11. A battery pack comprising:
the nonaqueous electrolyte battery according to claim 1,
a control part for controlling the nonaqueous electrolyte battery, and
a package for including the nonaqueous electrolyte battery therein.

12. An electronic appliance comprising the nonaqueous electrolyte battery according to claim 1, and receiving the supply of an electric power from the nonaqueous electrolyte battery.

13. An electric vehicle comprising
the nonaqueous electrolyte battery according to claim 1,
a conversion apparatus of receiving the supply of an electric power from the nonaqueous electrolyte battery and converting it to a driving force for the vehicle, and
a control apparatus for performing information processing regarding the vehicle control on the basis of the information regarding the nonaqueous electrolyte battery.

14. An electricity storage apparatus comprising the nonaqueous electrolyte battery according to claim 1 and supplying an electric power to an electronic appliance to be connected to the nonaqueous electrolyte battery.

15. The electricity storage apparatus according to claim 14,
including an electric power information control apparatus for transmitting and receiving signals relative to other appliance via a network, and
performing charge and discharge control of the nonaqueous electrolyte battery on the basis of the information which the electric power information control apparatus receives.

16. An electric power system for receiving the supply of an electric power from the nonaqueous electrolyte battery according to claim 1, or supplying an electric power to the nonaqueous electrolyte battery from an electric power generation apparatus or an electric power network.
